(19) United States
(12) Patent Application Publication
(10) Pub. No.: US 2011/0167184 A1
(43) Pub. Date: Jul. 7, 2011

(54) ACCESS CONTROL APPARATUS, DATA PROCESSING APPARATUS, ACCESS CONTROL METHOD, AND PROGRAM

(75) Inventors: Yoshito SUZUKI, Tokyo (JP); Makoto Kanemaru, Kanagawa (JP)

(73) Assignee: Sony Corporation, Tokyo (JP)

(21) Appl. No.: 12/958,632

(22) Filed: Dec. 2, 2010

(30) Foreign Application Priority Data
Jan. 5, 2010 (JP) 2010-000285

(51) Int. Cl. G06F 13/00

(52) U.S. Cl. 710/107

(57) ABSTRACT

An access control apparatus includes: a determination section; and an update section.

### BACKGROUND OF THE INVENTION

1. Field of the Invention

The present invention relates to an access control apparatus. More particularly, the invention relates to an access control apparatus, a data processing apparatus, and an access control method for providing access control on a plurality of data processing sections, as well as to a program for causing a computer to execute that access control method.

2. Description of the Related Art

Recent years have witnessed considerable increases in the speeds of data processing at diverse components inside computers as well as development of electronic devices. As the data processing speed of each of the components is getting higher, enhancing the efficiency of data transfers over the bus connecting the memory that stores data with devices (e.g., clients) that process data is demanded. Thus there have been proposed numerous data processing apparatuses for increasing the efficiency of data transfers illustratively over the bus that connects a plurality of clients with a memory.

One such proposed data processing apparatus is a bus control apparatus that detects the client with which data is to be exchanged on a round-robin basis using a counter value for successively identifying the multiple clients connected to the bus (e.g., see Japanese Patent Laid-Open No. Hei 3-130860 (FIG. 1)). This bus control apparatus assigns identifiers to the configured clients for identification purposes and has the value on a counter updated successively. While updating the counter value, the bus control apparatus supplies the updated counter value to all clients consecutively.

When a given client with its identifier identified by the supplied counter value is found requesting access to the memory, the bus control apparatus allows the client in question to access the memory. While the memory is being accessed, the counter value is stopped from getting updated. That is, if the client requesting access to the memory is found corresponding to the supplied counter value, that client is allowed to access the memory. If the access-requesting client is not found corresponding to the supplied counter value, then the client is not allowed to access the memory.

### SUMMARY OF THE INVENTION

According to the existing technique outlined above, only the counter value is supplied in order to determine the identifiers assigned to the clients. This helps alleviate the processing load of polling. However, the existing technique above entails stopping the counter value from getting updated while the allowed client is accessing the memory. It follows that the next client to be allowed to access the memory cannot be determined during the memory access operation. As a result, the efficiency of data transfers can deteriorate when a plurality of clients attempt to access the memory continuously.

The present invention has been made in view of the above circumstances and provides the arrangements for improving the efficiency of data transfers.

In carrying out the present invention and according to one embodiment thereof, there is provided an access control apparatus including: a determination section configured such that given a plurality of data processing sections each effecting a data transfer to and from a data holding section via a bus, the determination section selects one of the data processing sections as a candidate object to be enabled for the data transfer, the determination section further determining whether or not to supply an enable signal to the data processing section selected as the candidate object thereby enabling the candidate data processing section to perform the data transfer depending on whether or not the candidate data processing section is found outputting a request signal requesting the data transfer; and an update section configured such that while the data transfer is being performed based on the enable signal supplied as a result of the determination, the update section updates the current data processing section with another data processing section as the candidate object if the candidate data processing section selected as the next candidate object to be enabled for the data transfer is not found outputting the request signal. According to other embodiments of the invention, there is provided an access control method representing the functionality of the above-outlined access control apparatus, as well as a program for causing a computer to execute a procedure implementing that access control method. As the major effect of any one of these embodiments, while the data transfer is being carried out, the current data processing section is updated with the next candidate object to be enabled for the data transfer so that the next candidate object is successively detected.

Preferably, from the time the data transfer is started based on the enable signal supplied as a result of the determination until the time the data transfer is terminated, the update section may perform the update repeatedly in a predetermined sequence, the update section further stopping the update if the data processing section selected as the candidate object is found outputting the request signal. As the major effect of this structure, the update is repeated in a predetermined sequence until the data transfer period comes to an end, and the update is stopped if the data processing section selected as the candidate object is found outputting the request signal.

Preferably, while the data transfer is being performed based on the enable signal supplied as a result of the determination, if the data processing section selected as the candidate object as a result of the update is not found outputting the request signal, then the update section may perform the update repeatedly even after completion of the data transfer, the update section further stopping the update if the data processing section selected as the candidate object is found outputting the request signal. As the major effect of this structure, if the data processing section selected as the candidate object is not found outputting the request signal during the data transfer period, the update is repeated even upon elapse of that period.

Preferably, the plurality of data processing sections may be classified into a plurality of groups; the update section may identify one data processing section in each of the groups so as to perform the update by selecting the identified data processing section as the candidate per group; the access control apparatus may further include a selection section configured such that on the basis of the request signals output from the plurality of data processing sections, the selection section selects one of a plurality of candidates updated by the update section for each of the groups; and depending on whether the data processing section selected by the selection section as the candidate has output the request signal, the determination section may determine whether or not to supply the enable signal to the selected data processing section. As the major effect of this structure, one candidate object to be enabled next for the data transfer is selected from a plurality of candidates updated for each of the plurality of groups into which the data processing sections are classified.

In this case, the plurality of data processing sections may preferably be classified into the plurality of groups in such a manner that the data processing sections performing the same operation composed of either a read or a write are classified into the same group. As the major effect of this structure, the data processing sections are grouped so that only those performing the same operation are put in the same group. Also in this case, the access control apparatus of the invention may further include: a group information holding section configured to hold group information for identifying one of the plurality of groups; and a group update section configured to update the group information by successively updating the identified group with another group; wherein, if the request signal is supplied from the data processing section belonging to the group identified by the group information, then the selection section may select the candidate of the identified group as the one candidate; wherein, if the request signal is not supplied from the data processing section belonging to the group identified by the group information, then the selection section may select the candidate of another group other than the identified group as the one candidate. As the major effect of this structure, if the request signal is not supplied from the data processing section belonging to the group identified by the group information, then the candidate data processing section of another group is selected as the one candidate.

Preferably, the update section may continuously select the data processing section performing the same operation composed of either a read or a write as the next candidate object to be enabled for the data transfer. As the major effect of this structure, the data processing section performing the same operation consisting of either the read or the write is continuously selected as the candidate object to be enabled for the data transfer.

Preferably, from the time the data transfer is started based on the enable signal supplied as a result of the determination until the time the data transfer is terminated, the update section may perform the update repeatedly. As the major effect of this structure, the candidate object to be enabled for the data transfer is updated repeatedly.

Preferably, if the next candidate object to be enabled for the data transfer is the data processing section currently performing the data transfer based on the enable signal supplied as a result of the determination and if the data processing section in question is found outputting the request signal requesting the data transfer, then the update section may update the current data processing section with another data processing section as the candidate object. As the major effect of this structure, if the candidate object is performing the data transfer while outputting the request signal requesting the ongoing data transfer at the same time, the current data processing section is updated with another data processing section as the candidate object.

Preferably, the data processing section may stop outputting the request signal before the ongoing data transfer is terminated at the end of a predetermined data transfer period, so that the determination section may determine whether or not to supply the enable signal to the data processing section selected as the next candidate object to be enabled for the data transfer, between the time the data processing section currently performing the data transfer based on the enable signal during the data transfer period stops outputting the request signal, and the time the data transfer period comes to an end. As the major effect of this structure, while the data transfer period has yet to come to an end after the output of the request signal is terminated, it is determined whether or not to supply the enable signal to the data processing section selected as the next candidate object to be enabled for the data transfer between the time the output of the request signal is terminated and the time the data transfer is completed.

Preferably, the update section may include: an identification information holding section configured to hold identification information for identifying the data processing section as the next candidate object to be enabled for the data transfer; an identification information update section configured to update the identification information successively; and an identification information determination section configured to determine whether or not to perform the update while causing the identification information holding section to hold the identification information for identifying the data processing section selected as the candidate object as a result of the determination. As the major effect of this structure, on the basis of the successively updated identification information, it is determined whether or not to supply the enable signal to the next candidate object to be enabled for the data transfer.

According to yet another embodiment of the present invention, there is provided a data processing apparatus including: a data holding section configured to hold data; a plurality of data processing sections each configured to effect a data transfer to and from the data holding section; a bus configured to connect the data holding section with the plurality of data processing sections; a determination section configured to select one of the plurality of data processing sections as a candidate object to be enabled for the data transfer, the determination section further determining whether or not to supply an enable signal to the data processing section selected as the candidate object thereby enabling the candidate data processing section to perform the data transfer depending on whether or not the candidate data processing section is found outputting a request signal requesting the data transfer; and an update section configured such that while the data transfer is being performed based on the enable signal supplied as a result of the determination, the update section updates the current data processing section with another data processing section as the candidate object if the candidate data processing section selected as the next candidate object to be enabled for the data transfer is not found outputting the request signal. As the major effect of this structure, while the data transfer is being performed, the next candidate object to be enabled for the data transfer is updated with another data processing section, so that the data processing section as the candidate object to be enabled next for the data transfer is detected accordingly.

According to the present invention embodied illustratively as outlined above, the efficiency of data transfers is enhanced significantly.

### BRIEF DESCRIPTION OF THE DRAWINGS

Further features and advantages of the present invention will become apparent upon a reading of the following description and appended drawings in which:

FIG. 1 is a block diagram showing a functional composition example of a data processing apparatus as a first embodiment of the present invention;

FIG. 2 is a block diagram showing functional composition examples of an enabled client detection unit and an acknowledge signal supply unit of the first embodiment;

FIG. 3 is a timing chart showing how acknowledge signals are typically generated by the acknowledge signal supply unit of the first embodiment;

FIGS. 4A and 4B are timing charts showing how data is typically read (as read data) from a DRAM and how data is typically written (as write data) to the DRAM via a bus in the first embodiment;

FIG. 5 is a flowchart showing a typical enabled client detection process performed by the enabled client detection unit of the first embodiment;

FIG. 6 is a flowchart showing a typical acknowledge signal supply process performed by the acknowledge signal supply unit of the first embodiment;

FIG. 7 is a block diagram showing a functional composition example of a data processing apparatus as a second embodiment of the present invention;

FIG. 8 is a schematic view showing typical transitions of enabled target detection information effected by the enabled client detection unit of the second embodiment;

FIG. 9 is a timing chart showing how acknowledge signals are typically generated by the acknowledge signal supply unit of the second embodiment;

FIG. 10 is a schematic view showing typical transitions of enabled object detection information in effect where there exist large values of the enabled object detection information;

FIG. 11 is a timing chart showing how acknowledge signals are typically generated by the acknowledge signal supply unit where there exist large values of the enabled object detection information;

FIG. 12 is a block diagram showing a functional composition example of a data processing apparatus as a third embodiment of the present invention;

FIG. 13 is a block diagram showing a functional composition example of the acknowledge signal supply unit of the third embodiment;

FIGS. 14A and 14B are schematic views showing typical transitions of enabled target detection information in effect with the third embodiment;

FIG. 15 is a timing chart showing how acknowledge signals are typically generated by the acknowledge signal supply unit of the third embodiment;

FIG. 16 is a flowchart showing a typical enabled client detection process performed by a first enabled client detection unit of the third embodiment;

FIG. 17 is a flowchart showing a typical enabled client detection process performed by a second enabled client detection unit of the third embodiment;

FIG. 18 is a flowchart showing a typical acknowledge signal supply process performed by the acknowledge signal supply unit of the third embodiment;

FIG. 19 is a flowchart showing a typical ACK signal update value generation process (step S950 in FIG. 18) performed by the acknowledge signal supply unit of the third embodiment; and

FIG. 20 is a flowchart showing a typical count limit information updating process (step S970 in FIG. 18) performed by the acknowledge signal supply unit of the third embodiment.

### DETAILED DESCRIPTION OF THE PREFERRED EMBODIMENTS

The preferred embodiments of the present invention will now be described by reference to the accompanying drawings. The description will be given under the following headings:

1. First embodiment (for data processing control: an example in which the next client to carry out a data transfer is detected in parallel with a data transfer operation being performed by the current client);

2. Second embodiment (for data processing control: an example in which enabled target detection information is established in such a manner that the clients performing the same operation composed of either a read or a write are selected consecutively); and

3. Third embodiment (for data processing control: an example in which a plurality of enabled client detection units are provided).

### 1. First Embodiment

### Functional Composition Example of the Data Processing Apparatus 100

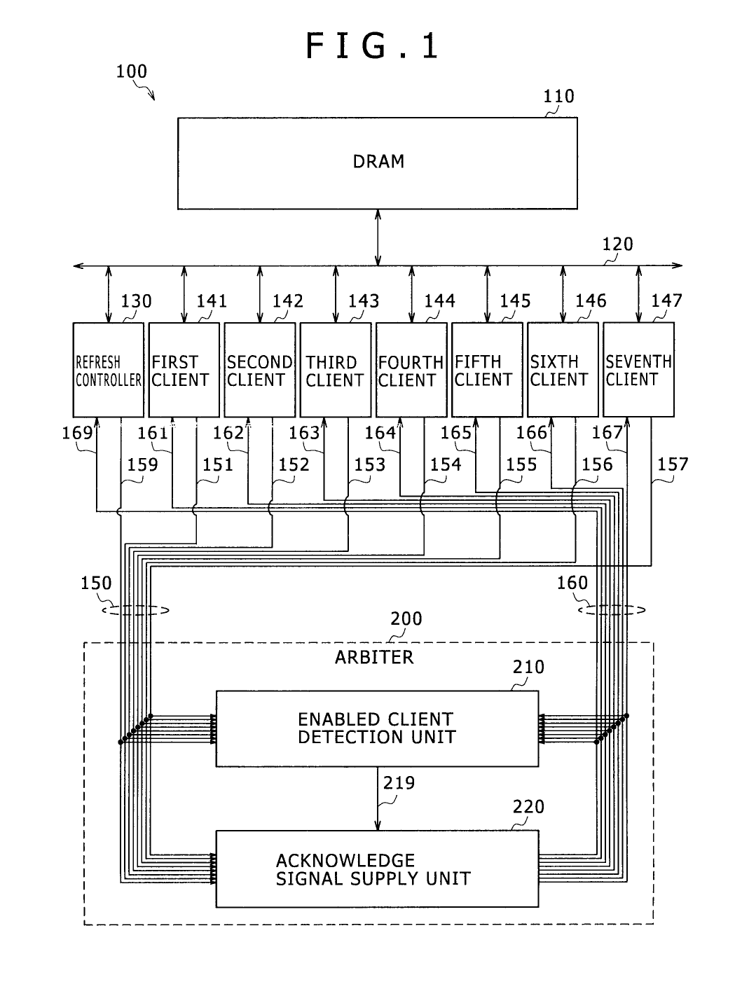

FIG. 1 is a block diagram showing a functional composition example of a data processing apparatus 100 as the first embodiment of the present invention. The data processing apparatus 100 includes a DRAM (dynamic random access memory) 110, a bus 120, a refresh controller 130, first through seventh clients 141 through 147, and an arbiter 200.

With the first embodiment, the refresh controller 130 is also considered to be a client, so that the refresh controller 130 and the first through the seventh clients 141 through 147 are all called clients. Also with the first embodiment, the signal for requesting a data transfer to or from the DRAM 110 (i.e., signal fed from a client to the arbiter 200) is called the request status signal. Furthermore, the signal for enabling the data transfer to or from the DRAM 110 (i.e., signal supplied from the arbiter 200 to a client) is called the enable status signal.

The DRAM 110 is a storage device to or from which data is written or read by the first through the seventh clients 141 through 147. Incidentally, the DRAM 110 is an example of the data holding section described in the appended claims.

The bus 120 interconnects the DRAM 110 with the first through the seventh clients 141 through 147. The bus 120 also interconnects the DRAM 110 with the refresh controller 130.

The refresh controller 130 controls refresh operations by periodically recharging the elements making up the DRAM 110. Via a REQ[0] line 159, the refresh controller 130 supplies the arbiter 200 with a request status signal (called the 0th request status signal). The 0th request status signal is a one-bit signal that indicates whether or not the refresh controller 130 is requesting permission to perform a refresh operation. The 0th request status signal has the bit value “1” when permission to effect a refresh operation is requested; the 0th request status signal has the bit value “0” when permission to effect a refresh operation is not requested. Illustratively, when the DRAM 110 needs to be refreshed, the refresh controller 120 changes the bit value from “0” to “1” in the 0th request status signal being output. Incidentally, the request status signal having the bit value “1” is an example of the request signal described in the appended claims.

Via an ACK[0] line 169, the refresh controller 130 is supplied with a signal giving permission to effect a refresh operation from the arbiter 200 (called the 0th enable status signal). The 0th enable status signal is a one-bit signal that indicates whether or not the refresh controller 1120 is enabled to perform a refresh operation. The 0th enable status signal has the bit value “1” when the refresh operation is enabled; the 0th enable status signal has the bit value “0” when the refresh operation is not enabled. Illustratively, if the 0th enable status signal having the bit value “1” is given via the ACK[0] line 169, the refresh controller 130 supplies the DRAM 110 over the bus 120 with a refresh command for causing the DRAM 110 to carry out a refresh operation. Incidentally, the refresh controller 130 is an example of the data processing section described in the appended claims.

The first through the seventh clients 141 through 147 transfer data to or from the DRAM 110 over the bus 120. The second through the seventh clients 142 through 147 are the same structurally and functionally as the first client 141, so that the ensuing description will focus primarily on the first client 141, with descriptions of the second through the seventh clients 142 through 147 partially omitted where redundant. Incidentally, the enable status signal having the bit value “1” is an example of the enable signal described in the appended claims.

When it is necessary to transfer data to or from the DRAM 110, the first client 141 supplies the arbiter 200 via a REQ[1] line 151 with the request status signal (called the first request status signal) whereby the first client 141 requests memory access. The first request status signal is a one-bit signal that indicates whether or not the first client 141 is requesting a data transfer. The first request status signal has the bit value “1” when the data transfer is requested; the first request status signal has the bit value “0” when the data transfer is not requested. Illustratively, when it becomes necessary to transfer data to or from the DRAM 110, the first client 141 changes the bit value from “0” to “1” in the first request status signal being output.

Also, the first client 141 is supplied with an enable status signal (called the first enable status signal) giving permission for data transfer from the arbiter 200 via an ACK[1] line 161. The first enable status signal is a one-bit signal that indicates whether or not the first client 141 is enabled to perform a data transfer. The first enable status signal has the bit value “1” when the data transfer is enabled; the first enable status signal has the bit value “0” when the data transfer is not enabled. Illustratively, if the first enable status signal having the bit value “1” is given through the ACK[1] line 161, the first client 141 performs a data transfer to or from the DRAM 110 via the bus 120.

The second through the seventh clients 142 through 147 are functionally the same as the first client 141. That is, the second client 142 outputs a second request status signal via a REQ[2] line 152; the third client 143 outputs a third request status signal via a REQ[3] line 153; the fourth client 144 outputs a fourth request status signal via a REQ[4] line 154; the fifth client 145 outputs a fifth request status signal via a REQ[5] line 155; the sixth client 146 outputs a sixth request status signal via a REQ[6] line 156; and the seventh client 147 outputs a seventh request status signal via a REQ[7] line 157.

Likewise, the second client 142 is supplied with a second enable status signal via an ACK[2] line 162; the third client 143 is supplied with a third enable status signal via an ACK[3] line 163; the fourth client 144 is supplied with a fourth enable status signal via an ACK[4] line 164; the fifth client 145 is supplied with a fifth enable status signal via an ACK[5] line 165; the sixth client 146 is supplied with a sixth enable status signal via an ACK[6] line 166; and the seventh client 147 is supplied with a seventh enable status signal via an ACK[7] line 167. Incidentally, the first through the seventh clients 141 through 147 are examples of the data processing sections described in the appended claims.

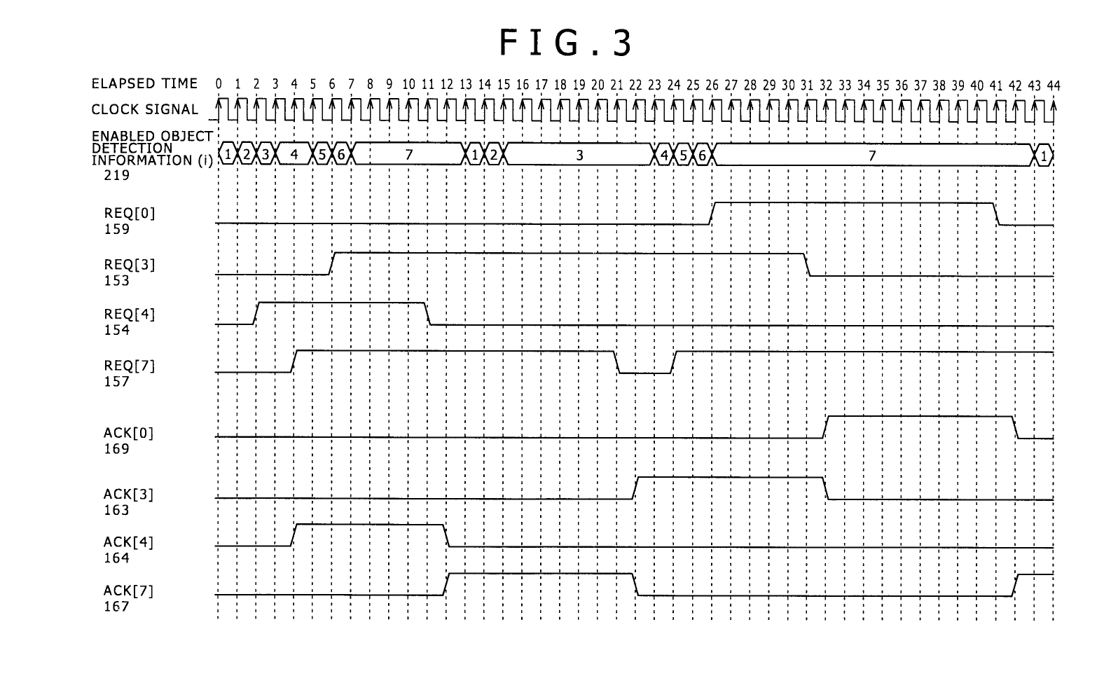

The arbiter 200 acts as an access control section that controls the refresh controller 130 and the first through the seventh clients 141 through 147 on the bus 120 to gain access to the DRAM 110 by way of the bus 120. The arbiter 200 provides bus arbitration in a manner determining which client should use the bus 120. Based on the 0th through the seventh request status signals (i.e., request signals) supplied via REQ lines 150, the arbiter 200 generates an acknowledge signal for the next cycle. In this context, a cycle refers a period of clock signal (clock cycle) in the arbiter 200. For example, a cycle refers illustratively to one elapsed time of the clock signal shown in FIG. 3. The acknowledge signal is a signal that enables the refresh controller 130 and the first through the seventh clients 141 through 147 to perform data transfers. The arbiter 200 sends the generated acknowledge signal over ACK lines 160 to the refresh controller 130 and to the first through the seventh clients 141 through 147. The REC lines 150 are a plurality of signal lines made up of the REQ[0] line 159 and REQ[1] through REQ[7] lines 151 through 157. The ACK lines 160 are a plurality of signal lines formed by the ACK[0] lines 169 and ACK[1] through ACK[7] lines 161 through 167. Incidentally, the arbiter 200 is an example of the access control apparatus described in the appended claims.

The arbiter 200 includes an enabled client detection unit 210 and an acknowledge signal supply unit 220.

The arbiter 200 uses as an eight-bit signal (i.e., request signal) the 0th through the seventh request status signals supplied from the refresh controller 130 and the first through the seventh clients 141 through 147. With the first embodiment of the invention, the arbiter 200 regards the 0th bit (LSB: least significant bit) of the request signal as the 0th request status signal, the first bit as the first request status signal, the second bit as the second request status signal, the third bit as the third request status signal, the fourth bit as the fourth request status signal, the fifth bit as the fifth request status signal, the sixth bit as the sixth request status signal, and the seventh bit (MSB: most significant bit) as the seventh request status signal.

Also, the arbiter 200 generates as an eight-bit signal (i.e., acknowledge signal) the 0th through the seventh enable status signals to be fed to the refresh controller 130 and to the first through the seventh clients 141 through 147, and supplies the bits making up the signal as the 0th through the seventh enable status signals. That is, with the first embodiment, the arbiter 200 provides the 0th bit (LSB) of the acknowledge signal as the 0th enable status signal, the first bit as the first enable status signal, the second bit as the second enable status signal, the third bit as the third enable status signal, the fourth bit as the fourth enable status signal, the fifth bit as the fifth enable status signal, the sixth bit as the sixth enable status signal, and the seventh bit (MSB) as the seventh enable status signal. Because the bus 120 is incapable of simultaneously transferring a plurality of bits, the maximum number of bits with the value “1” in this acknowledge signal is 1.

The enabled client detection unit 210 detects the next client to be enabled for another data transfer. The enabled client detection unit 210 updates successively the value of enabled object detection information for detecting the client to be enabled for the data transfer. Based on that enabled object detection information, on the request signal and on the acknowledge signal, the enabled client detection unit 210 detects the next client to be enabled for another data transfer. In this context, the enabled object detection information is information for designating the identifiers to be assigned individually to the clients. This information is used to detect the client to be enabled for the data transfer. Based on whether or not the client to which is assigned the identifier having the same value as that of the enabled object detection information (i.e., the candidate client to be enabled next for the data transfer) is outputting a request signal, the enabled client detection unit 210 determines whether or not that client is the next client to be enabled for the data transfer. If the enabled client detection unit 210 detects the client to be enabled next for the data transfer, then section 210 temporarily stops updating the enabled object detection information, thereby stopping temporarily the detection of a further client. Incidentally, the enabled object detection information is an example of the identification information described in the appended claims. Also, the client designated by the enabled object detection information is an example of the candidate object to be enabled for the data transfer as described in the appended claims.

If the acknowledge signal supply unit 220 enables the client to perform the data transfer, the enabled client detection unit 210 resumes detecting the next client to be enabled for another data transfer by updating the enabled object detection information even before the ongoing data transfer is terminated. Specifically, the enabled client detection unit 210 detects the next client to perform another data transfer in parallel with one of the first through the seventh clients 141 through 147 currently carrying out the data transfer.

However, if the client identified by the enabled object detection information as the next candidate to be enabled for the data transfer is found outputting the request status signal while the data transfer is underway, then the enabled client detection unit 210 stops updating the enabled object detection information. When the client identified by the enabled object detection information as the next candidate to be enabled for the data transfer is not found outputting the request status signal while the data transfer is underway, the enabled client detection unit 210 updates the enabled object detection information.

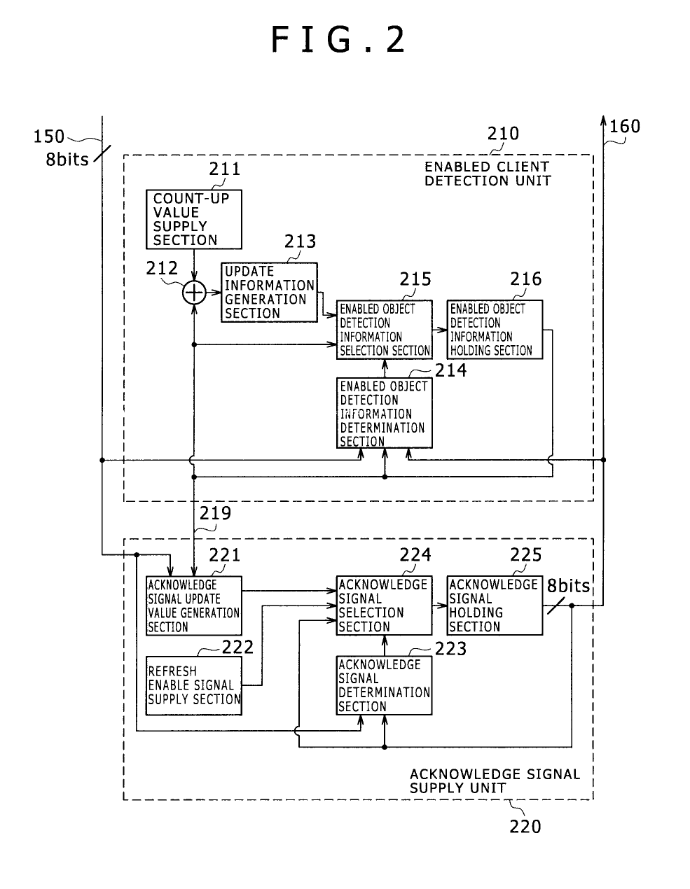

The enabled client detection unit 210 supplies the enabled object detection information to the acknowledge signal supply unit 220 via a signal line 219. The enabled client detection unit 210 will be discussed later in more detail by reference to FIG. 2. Incidentally, the enabled client detection unit 210 is an example of the update section described in the appended claims.

The acknowledge signal supply unit 220 determines whether or not to enable one of the clients requesting data transfers to effect the data transfer. The acknowledge signal supply unit 220 outputs the acknowledge signal based on the enabled object detection information and on the request signal. Suppose that the request status signal of the client identified by the enabled object detection information has the bit value “1” and that there is no client enabled to perform the data transfer. In such a case, the acknowledge signal supply unit 220 enables the client identified by the enabled object detection information to carry out its data transfer. That is, the acknowledge signal supply unit 220 determines whether or not to supply the enable status signal with the bit value “1” to the client identified by the enabled object detection information depending on whether the identified client has output the request signal having the bit value “1.”

Suppose also that the request status signal from the client identified by the enabled object detection information has the bit value “1” and that another client is being enabled to effect its data transfer. In this case, the acknowledge signal supply unit 220 enables the client identified by the enabled object detection information to effect its data transfer as soon as the ongoing data transfer comes to an end. If the refresh controller 130 is found outputting the 0th request status signal having the bit value “1,” the acknowledge signal supply unit 220 preferentially determines the refresh controller 130 as the next client to be enabled for the data transfer.

The acknowledge signal supply unit 220 supplies the bits of the generated acknowledge signal to the refresh controller 130 and to the first through the seventh clients 141 through 147 via the ACK lines 160. The acknowledge signal supply unit 220 will be discussed later in more detail by reference to FIG. 2. Incidentally, the acknowledge signal supply unit 220 is an example of the determination section described in the appended claims.

As described above, when the enabled client detection unit 210 and acknowledge signal supply unit 220 are installed together, it is possible efficiently to detect the next client to perform its data transfer while the data transfer of the current client is still underway.

### Functional Composition Examples of the Enabled Client Detection Unit 210 and Acknowledge Signal Supply Unit 220

FIG. 2 is a block diagram showing functional composition examples of the enabled client detection unit 210 and acknowledge signal supply unit 220 of the first embodiment. With the first embodiment, each client is assigned its own identifier for identification purposes. Specifically, an identifier “1” is assigned to the first client 141, “2” to the second client 142, “3” to the third client 143, “4” to the fourth client 144, “5” to the fifth client 145, “6” to the sixth client 146, and “7” to the seventh client 147.

Also with the first embodiment, the enabled object detection information is assumed to be a three-bit sequence (i.e., “001” through “111” indicating the values ranging from “1” to “7”) for purposes of description and illustration.

The enabled client detection unit 210 includes a count-up value supply section 211, an adder 212, an update information generation section 213, an enabled object detection information determination section 214, an enabled object detection information selection section 215, and an enabled object detection information holding section 216.

The count-up value supply section 211 supplies a count-up value by which to increment the value of the enabled object detection information by 1. Specifically, the count-up value supply section 211 retains as the count-up value the bit sequence to be added (i.e., “001” indicating the value “1”) to the bit sequence of the enabled object detection information, and supplies the retained count-up value successively to the adder 212.

The adder 212 adds up the value of the enabled object detection information supplied via the signal line 219 and the count-up value fed from the count-up value supply section 211. The adder 212 sends the sum (i.e., current value incremented by 1) to the update information generation section 213.

The update information generation section 213 generates the value of the enabled object detection information for the next cycle (i.e., update value of the enabled object detection information (update information)). If the sum added up by the adder 212 is found to exceed the maximum value “7” of the enabled object detection information, then the update information generation section 213 converts the sum to the minimum value “1” of the enabled object detection information. If the sum added up by the adder 212 is not in excess of the maximum value “7” of the enabled object detection information, then that sum is regarded as the value of the update information. That is, if the sum turns out to be “8,” the update information generation section 213 sets the value of the update information to “1.” If the sum is found to be one of the integers ranging from “1” to “7,” then that value is regarded as the value of the update information (one of 1 through 7). The update information generation section 213 supplies the update information thus generated to the enabled object detection information selection section 215.

What follows is an explanation of a typical process performed by the count-up value supply section 211, adder 212, and update information generation section 213. The process carried out by the three sections 211 through 213 may be represented by the following expression 1:

i=((i+1−i₀)mod N)+i₀ (1)

where, the letter i on the left-hand side of the expression 1 stands for update information; the letter i on the right-hand side denotes the enabled object detection information supplied via the signal line 219; the value “1” is a count-up value fed from the count-up value supply section 211; and the term i₀ represents the minimum value of the enabled object detection information. With the first embodiment of this invention, the value i₀ is “1.” The letter N stands for the maximum value of the enabled object detection information. With the first embodiment, the value N is “7.”

Suppose that the enabled object detection information supplied via the signal line 219 is “7.” In this case, the count-up value “1” is added up by the adder 212 to generate the sum “8.” This is that portion of the process which corresponds to the term “i+1” on the right-hand side of the expression 1 above. Then the update information generation section 213 subtracts the minimum value “1” of the enabled object detection information (id from the sum “8.” The resulting value “7” is divided by the maximum value “7” of the enabled object detection information (N), and the remainder is obtained (=0). The minimum value “1” of the enabled object detection information (i₀) is added to the remainder “0,” whereby the update information (update value “1”) is generated.

Suppose now that the enabled object detection information supplied via the signal line 219 is “2.” In this case, the count-up value “1” is added up by the adder 212 to generate the sum “3.” The update information generation section 213 then subtracts the minimum value “1” of the enabled object detection information (i₀) from the sum “3.” The difference “2” is divided by the maximum value “7” of the enabled object detection information (N) to obtain the remainder (=2). The minimum value “1” of the enabled object detection information (i₀) is then added to the remainder “2” to generate the update information (update value “3”). Incidentally, the count-up value supply section 211, adder 212, and update information generation section 213 are examples of the identification information update section described in the appended claims.

The enabled object detection information determination section 214 determines the enabled object detection information for the next cycle. Specifically, the enabled object detection information determination section 214 determines the enabled object detection information for the next cycle based on the acknowledge signal supplied via the ACK lines 160, on the request signal fed via the REQ lines 150, and on the enabled object detection information sent via the signal line 219. What follows is an explanation of the case where the value of the request status signal from the client identified by the enabled object detection information (i) is “0” (i.e., value of the i-th bit in the request signal (REQ[i] value)). In this case, the enabled object detection information determination section 214 supplies the command for selecting the update information (i.e., enabled object detection information update command) to the enabled object detection information selection section 215. Further explained below is the case where the REQ[1] value is “1.” In this case, the enabled object detection information determination section 214 determines the enabled object detection information for the next cycle by referencing the value of the enable status signal for the client identified by the enabled object detection information (i) (i.e., value of the i-th bit in the acknowledge signal (ACK[i] value)).

More specifically, if the REQ[i] value is “1” and if the ACK[i] value is “0,” then the enabled object detection information determination section 214 supplies the command for selecting the enabled object detection information for the current cycle (i.e., enabled object detection information wait command) to the enabled object detection information selection section 215. It should be noted that if the REQ[i] value is “1” and if the ACK[i] value is “0,” this is due to the detection of the client identified by the enabled object detection information (i) as the next client to be enabled for the data transfer. If both the REQ[i] value and the ACK[i] value are “1,” then the enabled object detection information determination section 214 supplies the enabled object detection information update command to the enabled object detection information selection section 215.

What follows is a detailed explanation of the case where both the REQ[i] value and the ACK[i] value are “1.” With the first embodiment of this invention, the REQ[i] value is changed from “1” to “0” in the cycle immediately preceding the one in which the data transfer comes to an end. The ACK[i] value is changed from “1” to “0” in the cycle in which the data transfer is terminated (e.g., at the elapsed time “11” of the ACK[4] line 164 shown in FIG. 3). That is, the first cycle in which both the REQ[i] value and the ACK[i] value are “1” is a cycle where the client identified by the enabled object detection information (i) starts the data transfer or is waiting for permission to effect the data transfer. In the example of FIG. 3, that first cycle corresponds to the elapsed time “4” of the ACK[4] line 164. Also, the last cycle in which both the REQ[i] value and the ACK[i] value are “1” is the cycle immediately preceding the one in which the data transfer comes to an end. In the example of FIG. 3, that last cycle corresponds to the elapsed time “10” of the ACK[4] line 164. The enabled object detection information update command supplied when both the REQ[i] value and the ACK[i] value are “1” initiates both the data transfer of the client identified by the enabled object detection information (i) and the detection of the next client to be enabled for the data transfer.

The enabled object detection information determination section 214 is implemented illustratively using an AND circuit that performs the AND of the request signal as well as the acknowledge signal and an eight-bit signal obtained by decoding the encoded three-bit enabled object detection information.

The enabled object detection information selection section 215 selects the enabled object detection information for the next cycle based on either the enabled object detection information update command or the enabled object detection information wait command fed from the enabled object detection information determination section 214. If the enabled object detection information update command is supplied, the enabled object detection information selection section 215 selects the updated information from the update information generation section 213 as the enabled object detection information for the next cycle. If the enabled object detection information wait command is supplied, then the enabled object detection information selection section 215 selects the enabled object detection information for the current cycle fed from the enabled object detection information holding section 216 via the signal line 219 as the enabled object detection information for the next cycle. The enabled object detection information selection section 215 sends the enabled object detection information thus selected to the enabled object detection information holding section 216.

The enabled object detection information holding section 216 holds the enabled object detection information selected by the enabled object detection information selection section 215. The enabled object detection information holding section 216 feeds the enabled object detection information thus retained to the adder 212, enabled object detection information determination section 214, and enabled object detection information selection section 215, as well as to an acknowledge signal update value generation section 221 via the signal line 219.

The acknowledge signal supply unit 220 includes the acknowledge signal update value generation section 221, a refresh enable signal supply section 222, an acknowledge signal determination section 223, an acknowledge signal selection section 224, and an acknowledge signal holding section 225.

The acknowledge signal update value generation section 221 generates the update value of the acknowledge signal (i.e., update acknowledge signal) which can become the acknowledge signal for the next cycle. If the REQ[i] value of the request signal supplied via the REQ lines 150 is “1,” the acknowledge signal update value generation section 221 generates an update acknowledge signal in which the ACK[i] value is “1” and all other bits are “0.” If the REQ[i] value of the request signal supplied via the REQ lines 150 is “0,” then the acknowledge signal update value generation section 221 generates an update acknowledge signal in which all other bits are “0.” For example, when supplied with the enabled object detection information having the value “2” and with a request signal in which the second bit has the value “1,” the acknowledge signal update value generation section 221 generates an update acknowledge signal in which the second bit is “1” and all other bits are “0.” Also, when supplied with the enabled object detection information having the value “2” and with a request signal in which the second bit has the value “0,” the acknowledge signal update value generation section 221 generates an update acknowledge signal in which all other bits are “0.” The acknowledge signal update value generation section 221 sends the update acknowledge signal thus generated to the acknowledge signal selection section 224.

The acknowledge signal update value generation section 221 is implemented illustratively using a circuit that performs the AND of the request signal and an eight-bit value obtained by decoding the encoded three-bit value of the enabled object detection information supplied via the signal line 219.

The refresh enable signal supply section 222 supplies the refresh controller 130 with the acknowledge signal giving permission to effect a refresh operation (i.e., refresh enable signal). Specifically, this is an acknowledge signal in which the 0th bit is “1” and all other bits are “0.” The refresh enable signal supply section 222 sends this refresh enable signal to the acknowledge signal selection section 224.

The acknowledge signal determination section 223 determines the acknowledge signal for the next cycle based on the acknowledge signal supplied via the ACK lines 160 and on the request signal fed via the REQ lines 150. The acknowledge signal determination section 223 first detects whether there exists a client which has sent a request status signal having the value “1” and to which an enable status signal having the value “1” is supplied. If the acknowledge signal determination section 223 detects the client with both signals having the value “1,” then the acknowledge signal determination section 223 sends the command for selecting the acknowledge signal of the current cycle (i.e., ACK wait command) to the acknowledge signal selection section 224.

If the acknowledge signal determination section 223 fails to detect any client with both signals having the value “1,” then the acknowledge signal determination section 223 determines the acknowledge signal for the next cycle based on the value of the 0th bit in the request signal. In this case, if the value of the 0th bit in the request signal is “1,” the acknowledge signal determination section 223 supplies the command for selecting the refresh enable signal (i.e., first ACK update command) to the acknowledge signal selection section 224. If the value of the 0th bit in the request signal is “0,” then the acknowledge signal determination section 223 supplies the command for selecting the update acknowledge signal (i.e., second ACK update command) to the acknowledge signal selection section 224.

The acknowledge signal selection section 224 selects the acknowledge signal for the next cycle based on the ACK wait command, first ACK update command, or second ACK update command supplied from the acknowledge signal determination section 223. If the ACK wait command is supplied, the acknowledge signal selection section 224 selects the acknowledge signal of the current cycle coming from the acknowledge signal holding section 225 via the ACK lines 160 as the acknowledge signal for the next cycle. If the first ACK update command is supplied, the acknowledge signal selection section 224 selects the refresh enable signal fed from the refresh enable signal supply section 222 as the acknowledge signal for the next cycle. If the second ACK update command is supplied, then the acknowledge signal selection section 224 selects the update acknowledge signal fed from the acknowledge signal update value generation section 221 as the acknowledge signal for the next cycle. The acknowledge signal selection section 224 sends the selected acknowledge signal to the acknowledge signal holding section 225.

The acknowledge signal holding section 225 holds the acknowledge signal selected by the acknowledge signal selection section 224. The acknowledge signal holding section 225 sends the acknowledge signal thus retained to the enabled object detection information determination section 214, acknowledge signal selection section 224, and acknowledge signal determination section 223 via the ACK lines 160. The acknowledge signal holding section 225 also supplies the bits of the retained acknowledge signal to the refresh controller 130 and to the first through the seventh clients 141 through 147.

The enabled object detection information for the next cycle and the acknowledge signal for the next cycle are generated in the manner described above based on the request signal of the current cycle, on the enabled object detection information of the current cycle, and on the acknowledge signal of the current cycle.

### Example of how the Acknowledge Signal is Generated by the Acknowledge Signal Supply Unit

FIG. 3 is a timing chart showing how acknowledge signals are typically generated by the acknowledge signal supply unit 220 of the first embodiment. In this chart, the horizontal axis denotes the values of the enabled object detection information (i), changes of the 0th request status signal on the REQ[0] line 159, and changes of the third request status signal on the REQ[3] line 153 relative to the clock signal being output during the operation of the arbiter 200. Also indicated along the horizontal axis of the timing chart are the changes of the fourth request status signal on the REQ[4] line 154, changes of the seventh request status signal on the REQ[7] signal 157, and changes of the 0th enable status signal on the ACK[0] line 169. Further shown in the timing chart are the changes of the third enable status signal on the ACK[3] line 163, changes of the fourth enable status signal on the ACK[4] line 164, and changes of the seventh enable status signal on the ACK[7] line 167.

It should be noted that in the timing chart of FIG. 3, the elapsed time is indicated by the clock cycle count.

With the first embodiment of this invention, it is assumed that the time period in which to transfer read or write data is 8 clock cycles long. It is also assumed that a wait time of 2 clock cycles occurs upon changeover from read access to write access or vice versa, that a wait time of 2 clock cycles occurs upon changeover from read or write access to a refresh, and that a wait time of 2 clock cycles also occurs upon changeover from a refresh to read or write access.

With the first embodiment of the invention, it is assumed that from the time the supply of the enable status signal having the value “1” is started until the time the supply is terminated, an access command is sent to the DRAM 110 via the bus 120.

With the first embodiment, it is also assumed that no wait time occurs when a read access operation is followed by another read access operation or when a write access operation is followed by another write access operation, thereby to carry out the next operation.

With this example, it is assumed for purposes of simplification and illustration that the value is “0” on the REQ[1] line 151, REQ[2] line 152, REQ[5] line 155, and REQ[6] line 156. For this reason, the REQ[1] line 151, REQ[2] line 152, REQ[5] line 155, and REQ[6] line 156 are not shown in FIG. 3 and their descriptions are omitted hereunder.

Likewise with this example, it is assumed that the value is “0” on the ACK[1] line 161, ACK[2] line 162, ACK[5] line 165, and ACK[6] line 166. For this reason, the ACK[1] line 161, ACK[2] line 162, ACK[5] line 165, and ACK[6] line 166 are not shown in FIG. 3 and their descriptions are omitted hereunder.

In FIG. 3, it is assumed that the 0th request status signal on the REQ[0] line 159 is changed from “0” to “1” at the elapsed time “26,” that the third request status signal on the REQ[3] line 153 is changed from “0” to “1” at the elapsed time “6,” that the fourth request status signal on the REQ[4] line 154 is changed from “0” to “1” at the elapsed time “2,” and that the seventh request status signal on the REQ[7] line 157 is changed from “0” to “1” at the elapsed time “4.”

Also with regard to FIG. 3, it is assumed that the data transfer request on the REQ[3] line 153 at the elapsed time “6” is a data transfer request for a read access operation, that the data transfer request on the REQ[4] line 154 at the elapsed time “2” is also a data transfer request for a read access operation, and that the data transfer request on the REQ[7] line 157 at the elapsed time “4” is a data transfer request for a write access operation.

The value of the enabled object detection information at the elapsed time “0” is assumed to be “1” identifying the first client 141.

At the elapsed time “0,” all eight bits constituting the acknowledge signal supplied by the acknowledge signal supply unit 220 are assumed to be “0.”

The operations depicted in FIG. 3 will be explained below with emphasis on the enabled object detection information and acknowledge signal supplied by the enabled client detection unit 210 and acknowledge signal supply unit 220 respectively.

Explained first are the enabled object detection information and acknowledge signal supplied by the enabled client detection unit 210 and acknowledge signal supply unit 220 at the elapsed time “0.” The enabled object detection information holding section 216 feeds the value “1” retained to the adder 212, the enabled object detection information determination section 214, enabled object detection information selection section 215, and acknowledge signal update value generation section 221 via the signal line 219. The acknowledge signal holding section 225 supplies the retained acknowledge signal having all of its eight bits set to “0” to the enabled object detection information determination section 214, acknowledge signal selection section 224, and acknowledge signal determination section 223 via the ACK lines 160. Furthermore, the acknowledge signal holding section 225 feeds individually the eight “0” bits making up the retained acknowledge signal to the refresh controller 130 and to the first through the seventh clients 141 through 147.

Explained next are the operations performed by the enabled client detection unit 210 for determining the enabled object detection information at the elapsed time “0.” First, the adder 212 supplies the update information generation section 213 with the sum “2” obtained by adding the count-up value “1” fed from the count-up value supply section 21 to the enabled object detection information “1.” Based on the sum “2,” the update information generation section 213 generates the update information “2” and sends the generated information “2” to the enabled object detection information selection section 215 based on the sum “2”. When supplied with the value “1” held in the enabled object detection information holding section 216, the enabled object detection information determination section 214 determines the enabled object detection information at the elapsed time “1” simultaneously with the update information being generated by the update information generation section 213. Because the first request status signal on the REQ[1] line 151 is “0” at the elapsed time “0,” the enabled object detection information determination section 214 sends the enabled object detection information update command to the enabled object detection information selection section 215.

Between the update information “2” generated by the update information generation section 213 and the enabled object detection information “1” of the current cycle supplied via the signal line 219, the enabled object detection information selection section 215 selects the update information “2.” The enabled object detection information selection section 215 proceeds to feed the selected update information “2” to the enabled object detection information holding section 216 as the enabled object detection information for the next cycle. At the elapsed time “0,” the enabled object detection information “2” for the elapsed time “1” is generated as described above. The generated enabled object detection information “2” is held by the enabled object detection information holding section 216.

Explained below are the operations performed by the acknowledge signal supply unit 220 for determining the acknowledge signal at the elapsed time “0.” First, the acknowledge signal update value generation section 221 generates an update acknowledge signal in which all bits are “0,” based on the enabled object detection information “1” and on the request signal having all of its eight bits set to “0.” The acknowledge signal determination section 223 determines the acknowledge signal at the elapsed time “1” based on the request signal in which all eight bits are “0” and on the acknowledge signal in which all eight bits are also “0.” Given the request signal and acknowledge signal, the acknowledge signal determination section 223 determines that there is no client regarding which both the value of the request status signal and that of the enable status signal are “1.” Since the 0th bit of the request signal is “0,” the acknowledge signal determination section 223 supplies the second ACK update command to the acknowledge signal selection section 224. In turn, the acknowledge signal selection section 224 selects the update acknowledge signal which was fed from the acknowledge signal update value generation section 221 and in which all bits are “0,” and sends the selected acknowledge signal to the acknowledge signal holding section 225. At the elapsed time “0,” the acknowledge signal for the elapsed time “1” is generated as described above. The generated acknowledge signal is held by the acknowledge signal holding section 225.

The operations at the elapsed time “1” are the same as those at the elapsed time “0” and thus will not be explained further. At the elapsed time “1,” the enabled object detection information for the elapsed time “2” is determined to be “3.”

At the elapsed time “2,” the fourth request status signal on the REQ[4] line 154 is changed from “0” to “1.” Because at the elapsed time “2” the third request status signal on the REQ[3] line 153 is “0” regarding the client identified by the enabled object detection information “3,” the enabled object detection information determination section 214 supplies the enabled object detection information update command to the enabled object detection information selection section 215. At the elapsed time “2,” the enabled object detection information “4” for the elapsed time “3” is determined as described above. The enabled object detection information “4” thus determined is held by the enabled object detection information holding section 216. The operations of the acknowledge signal supply unit 220 are the same as those performed at the elapsed time “0.”

At the elapsed time “3,” the fourth request status signal on the REQ[4] line 154 is “1” regarding the client identified by the enabled object detection information “4.” Thus the enabled object detection information determination section 214 determines the enabled object detection information for the next cycle by also referencing the value of the fourth enable status signal in the acknowledge signal (i.e., value on the ACK[4] line 164). Because at the elapsed time “3” the value on the ACK[4] line 164 is “0,” the enabled object detection information determination section 214 supplies the enabled object detection information wait command to the enabled object detection information selection section 215. In the manner described above, the enabled object detection information “4” for the elapsed time “4” is determined. The enabled object detection information “4” thus determined is held by the enabled object detection information holding section 216.

At the elapsed time “3,” the acknowledge signal update value generation section 221 determines an update acknowledge signal in which the fourth bit is “1,” based on the enabled object detection information “4” and on the request signal in which the fourth bit is “1” (i.e., value on the REQ[4] lines 154). The acknowledge signal determination section 223 determines the acknowledge signal for the elapsed time “4” based on the request signal in which the fourth bit is “1” (i.e., value on the REQ[4] line 154) and on the acknowledge signal in which all eight bits are “0.” Given these two signals, the acknowledge signal determination section 223 determines that there is no client regarding which both the value of the request status signal and that of the enable status signal are “1.” Because the fourth bit of the request signal is “1” (i.e., value on the REQ[4] line 154), the acknowledge signal determination section 223 supplies the second ACK update command to the acknowledge signal selection section 224. In turn, the acknowledge signal selection section 224 selects the update acknowledge signal which was fed from the acknowledge signal update value generation section 221 and in which the fourth bit is “1,” and sends the selected acknowledge signal to the acknowledge signal holding section 225. At the elapsed time “3,” the acknowledge signal for the elapsed time “4” is determined as described above (i.e., signal in which the fourth bit is “1”). The acknowledge signal thus determined is held by the acknowledge signal holding section 225.

At the elapsed time “4,” the fourth enable status signal on the ACK[4] line 164 is “1.” This enables the fourth client 144 to start its data transfer (read access) from the DRAM 110. Since no write access operation was made immediately before the elapsed time “4,” there is no wait time. The fourth client 144 thus carries out its read access operation during the eight-cycle period ranging from the elapsed time “4” to the elapsed time “11.”

At the elapsed time “4,” the value of the enabled object detection information is “4,” and the fourth bit of the request signal (i.e., value on the REQ[4] line 154) and its seventh bit (value on the REQ[7] 157) are both “1.” Also, the fourth bit of the acknowledge signal (value on the REQ[4] line 154) is “1.” Because both the fourth request status signal from the client identified by the enabled object detection information “4” and the fourth enable status signal have the value “1,” the enabled object detection information determination section 214 sends the enabled object detection information update command to the enabled object detection information selection section 215. The enabled object detection information “5” is determined for the elapsed time “5” as described above. The enabled object detection information “5” thus determined is held by the enabled object detection information holding section 216.

Because at the elapsed time “4” the value on the REQ[4] line 154 is “1” and the value on the ACK[4] line 164 is also “1,” the acknowledge signal determination section 223 supplies the ACK wait command to the acknowledge signal selection section 224. This allows the acknowledge signal for the elapsed time “5” to be determined (i.e., fourth bit of the signal is set to “1”). The acknowledge signal thus determined is held by the acknowledge signal holding section 225.

The operations of the enabled client detection unit 210 at the elapsed times “5” and “6” are the same as those at the elapsed time “0” and thus will not be described further. At the elapsed time “6,” the enabled object detection information for the elapsed time “7” is determined to be “7.” Also, the operations of the acknowledge signal supply unit 220 at the elapsed times “5” and “6” are the same as those at the elapsed time “4” and thus will not be explained further.

At the elapsed time “7,” the enabled object detection information is “7,” and the request signal is one in which the third bit value (i.e., value on the REQ[3] line 153), the fourth bit value (on the REQ[4] line 154), and the seventh bit value (on the REQ[7] line 157) are “1” each. The acknowledge signal has its fourth bit value (on the ACK[4] line 164) set to “1.” Because the seventh enable status signal is “0” although the seventh request status signal from the client identified by the enabled object detection information “7” is “1,” the enabled object detection information determination section 214 sends the enabled object detection information wait command to the enabled object detection information selection section 215. This allows the enabled object detection information “7” for the elapsed time “8” to be determined. The enabled object detection information “7” thus determined is held by the enabled object detection information holding section 216. The operations of the acknowledge signal supply unit 220 at the elapsed time “7” are the same as those at the elapsed time “4” and thus will not be described further.

Up to the elapsed time “10,” the enabled object detection information remains at the value “7.” The acknowledge signal has its fourth bit value (i.e., value on the ACK[4] line 164) held at “1.”

At the elapsed time “10,” the fourth client 144 changes the fourth request status signal from “1” to “0” on the REQ[4] line 154, and notifies the host that read access will occur in the next cycle. As a result, the request signal for the elapsed time “11” has the value of its third bit (i.e., value on the REQ[3] line 153) and the value of its seventh bit (value on the REQ[7] line 157) set to “1” each.

At the elapsed time “11,” the enabled client detection unit 210 places the enabled object detection information “7” unchanged into the enabled object detection information holding section 216. What follows is an explanation of the operations performed by the acknowledge signal supply unit 220 at the elapsed time “11” for determining the acknowledge signal. The acknowledge signal update value generation section 221 generates an update acknowledge signal in which the value of the seventh bit (i.e., value on the ACK[7] line 167) is “1,” based on the enabled object detection information “7” and on the request signal in which the third bit and the seventh bit are “1” each. The acknowledge signal determination section 223 determines that there is no client detected regarding which both the request status signal and the enable status signal have the value “1.” As a result, the acknowledge signal determination section 223 determines the acknowledge signal for the next cycle based on the value of the 0th bit in the request signal. Because at the elapsed time “11” the value of the 0th bit in the request signal (i.e., value on the REQ[0] line 159) is “0,” the acknowledge signal determination section 223 sends the second ACK update command to the acknowledge signal selection section 224. At the elapsed time “11,” the acknowledge signal (with the seventh bit set to “1”) for the elapsed time “12” is determined as described above. The acknowledge signal thus determined is held by the acknowledge signal holding section 225.

At the elapsed time “12,” the seventh enable status signal on the ACK[7] line 167 is “1.” This causes the seventh client 147 to start its data transfer to the DRAM 110 (i.e., write access operation). Because the operation on the DRAM 110 immediately before the elapsed time “12” was a read access operation whereas the operation to be performed by the seventh client 147 on the DRAM 110 is a write access operation, a wait time of two cycles is needed at the DRAM 110. Thus at the elapsed times “12” and “13,” the seventh client 147 stays in a wait state without starting the supply of a write access command. At the elapsed time “14,” the seventh client 147 starts supplying the write access command. During the eight-cycle period up to the elapsed time “21,” the seventh client 147 performs the write operation on the DRAM 110.

The operations of the enabled client detection unit 210 and of the acknowledge signal supply unit 220 from the elapsed time “12” to the elapsed time “21” are the same as those explained up to the elapsed time “11,” with some changes in the values of the signals involved. Thus these operations will not be discussed further.

At the elapsed time “21,” the enabled object detection information for the elapsed time “22” is determined to be “3,” and the acknowledge signal is determined to be one in which the value of the third bit (i.e., value on the ACK[3] line 163) is “1.”

At the elapsed time “22,” the third enable status signal on the ACK[3] line 163 is “1.” This enables the third client 143 to start its data transfer from the DRAM 110 (i.e., read access operation). Because the operation on the DRAM 110 immediately before the elapsed time “22” was a write access operation whereas the operation to be performed by the third client 143 on the DRAM 110 is a read access operation, a wait time of two cycles is needed at the DRAM 110. Thus at the elapsed times “22” and “23,” the third client 143 stays in a wait state without starting the supply of read access command. At the elapsed time “24,” the third client 143 starts supplying the read access command. During the eight-cycle period up to the elapsed time “31,” the third client 143 performs the read operation on the DRAM 110.

The operations of the enabled client detection unit 210 and of the acknowledge signal supply unit 220 from the elapsed time “22” to the elapsed time “30” are the same as those explained up to the elapsed time “11,” with some changes in the values of the signals involved. Thus these operations will not be discussed further.

At the elapsed time “30,” the enabled object detection information for the elapsed time “31” is determined to be “7,” and the acknowledge signal is determined to be one in which the value of the third bit (i.e., value on the ACK[3] line 163) is “1.” Also at the elapsed time “30,” the third client 143 changes the third request status signal on the REQ[3] line 153 from “1” to “0” and thereby notifies the host that the read access operation will be completed in the next cycle. This brings about at the elapsed time “31” a request signal in which both the value of the 0th bit (value on the REQ[0]line 159) and the value of the seventh bit (value on the REQ[7] line 157) are “1” each.

At the elapsed time “31,” the enabled client detection unit 210 places the enabled object detection information “7” unchanged into the enabled object detection information holding section 216. What follows is an explanation of the operations performed by the acknowledge signal supply unit 220 at the elapsed time “31” for determining the acknowledge signal. The acknowledge signal update value generation section 221 first generates an update acknowledge signal in which the value of the seventh bit (i.e., value on the ACK[7] line 167) is “1.” The acknowledge signal determination section 223 determines that there is no client detected regarding which both the request status signal and the enable status signal have the value “1.” As a result, the acknowledge signal determination section 223 determines the acknowledge signal for the next cycle based on the value of the 0th bit in the request signal. Because at the elapsed time “31” the value of the 0th bit in the request signal (i.e., value on the REQ[0] line 159) is “1,” the acknowledge signal determination section 223 sends the first ACK update command to the acknowledge signal selection section 224. The acknowledge signal selection section 224 then selects the refresh enable signal fed from the refresh enable signal supply section 222, and sends the selected refresh enable signal to the acknowledge signal holding section 225. At the elapsed time “31,” the acknowledge signal (with the 0th bit set to “1”) for the elapsed time “32” is determined as described above. The acknowledge signal thus determined is held by the acknowledge signal holding section 225.

At the elapsed time “32,” the 0th enable status signal on the ACK[0] line 169 is “1.” This causes the refresh controller 130 to start feeding a refresh command to the DRAM 110. Because the operation on the DRAM 110 immediately before the elapsed time “32” was a read access operation whereas the operation to be performed by the refresh controller 130 on the DRAM 110 is a refresh operation, a wait time of two cycles is needed at the DRAM 110. Thus at the elapsed times “32” and “33,” the refresh controller 130 stays in a wait state without starting the supply of a refresh command. At the elapsed time “34,” the refresh controller 130 starts supplying the refresh command. During the eight-cycle period up to the elapsed time “41,” the refresh controller 130 performs the refresh operation on the DRAM 110.

The operations of the enabled client detection unit 210 and of the acknowledge signal supply unit 220 from the elapsed time “32” up to the elapsed time “43” are the same as those explained above, with some changes in the values of the signals involved. Thus these operations will not be discussed further.

When the next client to perform its data transfer is detected as described while the current client is being enabled to carry out its data transfer, it is possible to reduce the number of cycles in which to wait for the next client to be detected.

### [Typical Effects of the Data Processing Apparatus]

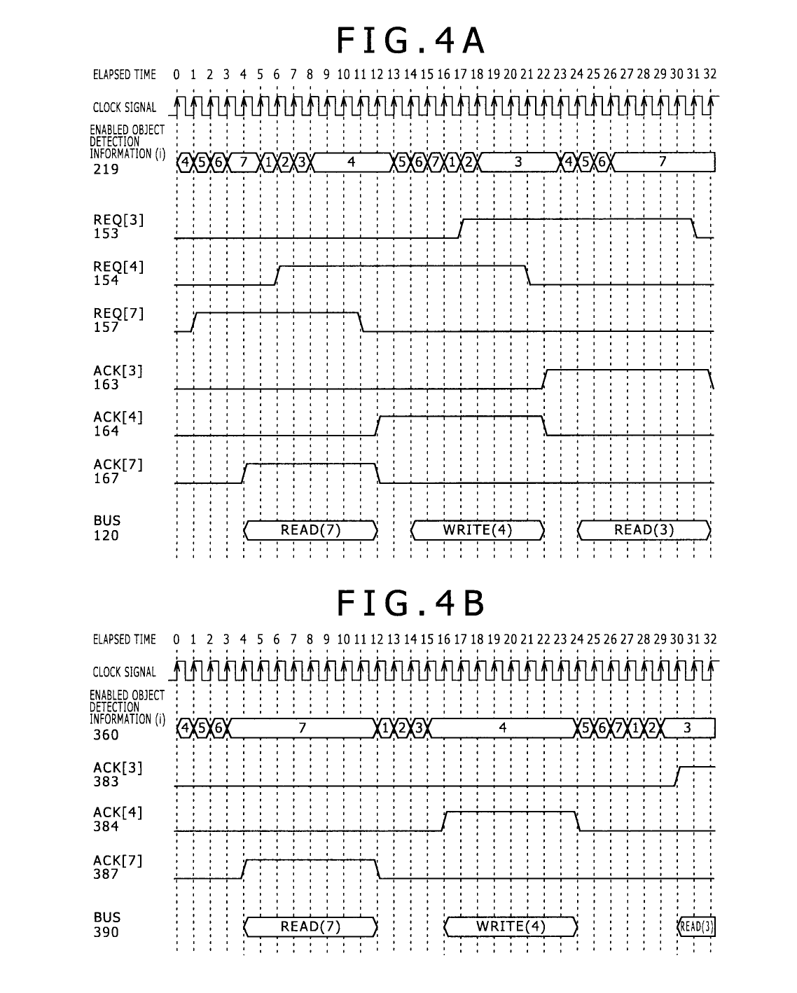

FIGS. 4A and 4B are timing charts showing how data is typically read (as read data) from the DRAM 110 and how data is typically written (as write data) to the DRAM 110 via the bus 120 in the first embodiment of this invention. Explained below are the major differences between the data processing apparatus 100 of the embodiment and an ordinary data processing apparatus, the inventive data processing apparatus 100 detecting the next client to be enabled for another data transfer while the current data transfer is still underway, the ordinary data processing apparatus detecting the next client to be enabled for the data transfer after completion of the current data transfer.

FIG. 4A shows an example in which data transfers are carried out by the data processing apparatus 100 of the first embodiment. In FIG. 4A, the horizontal axis denotes the values of the enabled object detection information (i) 219 and the changes of the third request status signal on the REQ[3] line 153 relative to the clock signal being output during the operation of the arbiter 200. Also indicated along the horizontal axis are the changes of the fourth request status signal on the REQ[4] line 154, changes of the seventh request status signal on the REQ[7] signal 157, and changes of the third enable status signal on the ACK[3] line 163. Further shown in this timing chart are the changes of the fourth enable status signal on the ACK[4] line 164 and the changes of the seventh enable status signal on the ACK[7] line 167, together with read data and write data transferred via the bus 120.

In FIGS. 4A and 4B, the operations performed by the enabled client detection unit 210 and acknowledge signal supply unit 220 are the same as those shown in FIG. 3 and thus will not be described further. The other operations in FIGS. 4A and 4B are explained below with emphasis on the data to be transferred via the bus 120.

For purposes of simplification and illustration of the first embodiment, delays are not considered during the period where the enable status signal is fed to a client, during the period where that client issues commands to the DRAM 110, and during the period where data is transmitted from the DRAM 110. In FIG. 4A, when the enable status signal having the value “1” is sent to a client, the DRAM 110 waits for data to be transferred thereto or performs a data transfer based on the enable status signal in the cycles where the enable status signal is being fed. Where the DRAM 110 performs the data transfer, the data is transferred via the bus 120 in the cycles where the enable status signal is supplied.

What follows is an explanation of the data transferred by the first embodiment via the bus 120 with emphasis on the use of the bus 120 as shown in FIG. 4A. Between the elapsed time “4” and the elapsed time “11,” the seventh client 147 transfers a read access command to the DRAM 110 and the read data retrieved from the DRAM 110 is transferred therefrom. At the elapsed times “12” and “13,” a wait time occurs to allow the fourth client 144 to transfer a write access command to the DRAM 110 in a manner averting the conflict with the immediately preceding read access operation over bus use. From the elapsed time “14” up to the elapsed time “21,” the seventh client 147 transfers a write access command to the DRAM 110 and the write data to be written to the DRAM 110 is transferred thereto.

Then at the elapsed times “22” and “23,” a wait time occurs to allow the third client 143 to transfer a read access command to the DRAM 110 in a manner averting the conflict with the immediately preceding write access operation over bus use. Between the elapsed time “24” and the elapsed time “31,” the third client 143 transfers a read access command to the DRAM 110 and the read data retrieved from the DRAM 110 is transferred therefrom.

FIG. 4B shows an example in which the ordinary apparatus detects the next client to be enabled for the data transfer after completion of the current data transfer. In FIG. 4B, the horizontal axis denotes the values of enabled object detection information (i) 360 and the changes of the third enable status signal on an ACK[3] line 383 relative to the clock signal being output during the operation of the arbiter 200. Also shown in this timing chart are the changes of the fourth enable status signal on an ACK[4] line 384 and the changes of the seventh enable status signal on an ACK[7] line 387, together with read data and write data transferred via a bus 390.

In FIG. 4B, the timing for the transition from “0” to “1” in the request signal is the same as the timing for the request signal shown in FIG. 4A. The ordinary data processing apparatus whose workings are depicted in FIG. 4B is assumed to have the same structure as that the data processing apparatus 100 of the first embodiment except for the arbiter 200. Specifically, the ACK[3] line 383 corresponds to the ACK[3] the line 163, ACK[4] line 384 to the ACK[4] 164, the ACK[7] line 387 to the ACK[7] line 167, and the bus 390 to the bus 120.

It is assumed that the arbiter of the ordinary data processing apparatus depicted in reference to FIG. 4B does not update the value of the enabled object detection information during the period where data is being transferred via the bus 390.

Below is a brief explanation of the enabled object detection information and acknowledge signal of the ordinary data processing apparatus. From the elapsed time “0” to the elapsed time “3,” the enabled object detection information and acknowledge signal of the ordinary data processing apparatus are the same as those of the first embodiment. At the elapsed time “4,” the data transfer effected by the client identified by the enabled object detection information “7” has yet to be completed. Thus the arbiter of the ordinary data processing apparatus sets the value of the enabled object detection information for the elapsed time “5” to “7” which is the same as the value of the current cycle. This operation is continued up to the elapsed time “11.”

At the elapsed time “11,” the arbiter of the ordinary data processing apparatus receives the request status signal (not shown) having the value “0” indicating the end of the data transfer from the client identified by the enabled object detection information “7.” In turn, the arbiter sets the value of the enabled object detection information for the elapsed time “12” to “1.” Then the arbiter of the ordinary apparatus resumes detecting the next client to be enabled for another data transfer.

At the elapsed time “15,” the value of the enabled object detection information is “4” and the request status signal from the client identified by the enabled object detection information “4” is “1.” As a result, the updating of the value of the enabled object detection information is stopped and an acknowledge signal in which the fourth bit is “1” is generated. The enabled object detection information having the value “4” is then supplied until the data transfer by the client identified by the enabled object detection information “4” is terminated at the elapsed time “23.” At the same time, the acknowledge signal in which the value of the fourth bit (i.e., value on the ACK[4] line 384) is “1” is supplied.

At the elapsed time “23,” as at the elapsed time “11,” the detection of the next client to perform a data transfer is resumed. Later at the elapsed time “29,” the updating of the value of the enabled object detection information is stopped and an acknowledge signal in which the third bit is “1” is generated. At the elapsed time “30,” the acknowledge signal in which the value of the third bit (i.e., value on the ACK[3] line 383) is “1” is supplied.

That is, as indicated by the operations on the bus 390 in FIG. 4B, the ordinary data processing apparatus allows the client identified by the enabled object detection information “7” to transfer a read access command to the DRAM 110 between the elapsed time “4” and the elapsed time “11.” At the same time as the transfer of the command from the elapsed time “4” up to the elapsed time “11,” the read data retrieved from the DRAM 110 is transferred. Between the elapsed time “12” and the elapsed time “15,” the arbiter detects the next client to be enabled for the data transfer so that there is no data being transferred during this period. From the elapsed time “16” up to the elapsed time “23,” the fourth client 144 transfers a write access command to the DRAM 110 and the write data to be read from the DRAM 110 is transferred concurrently thereto. Between the elapsed time “24” and the elapsed time “29,” the arbiter detects the next client to be enabled for a data transfer so that no data is transferred via the bus 390 during this period. At the elapsed times “30” and “31,” the first two cycles of read access by the third client 143 takes place.

As described, if the next client to be enabled for another data transfer is detected while the current client is being enabled to carry out its data transfer, it is possible to improve the efficiency of bus use.

### [Typical Operations of the Arbiter]

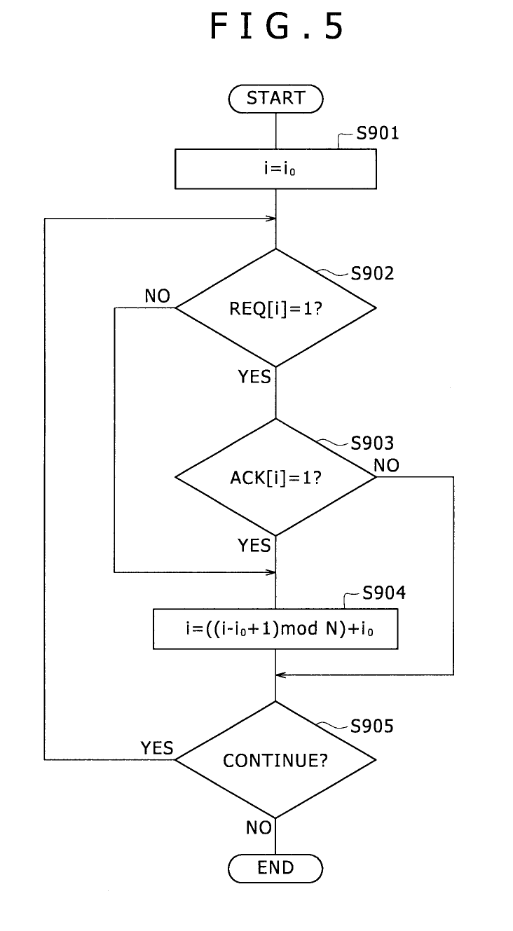

FIG. 5 is a flowchart showing a typical enabled client detection process performed by the enabled client detection unit 210 of the first embodiment of this invention.

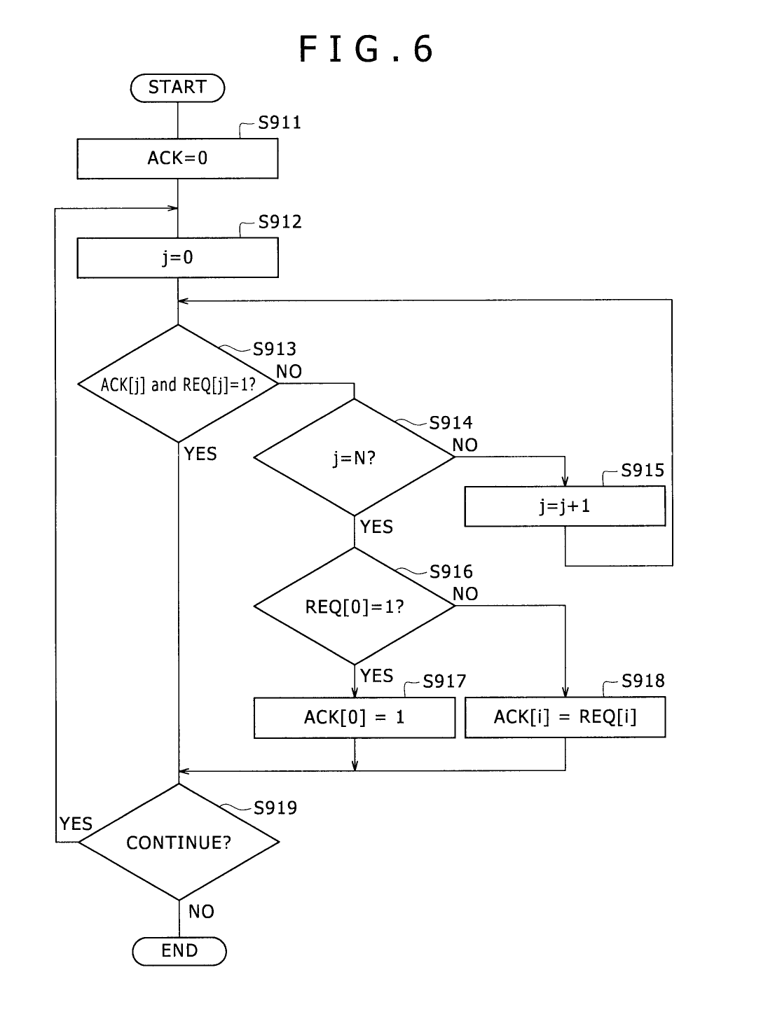

The enabled object detection information (i), the minimum value of the enabled object detection information (i₀), the REQ[i] value, the ACK[i] value, and the maximum value of the enabled object detection information (N) to be indicated in FIGS. 5 and 6 are the same as those shown in FIG. 2 and thus will not be discussed further.

The enabled object detection information (i) held by the enabled object detection information holding section 216 is first initialized to the minimum value (i₀) (in step S901). Step S901 is typically carried out immediately after power is applied to the data processing apparatus 100.

The enabled object detection information determination section 214 then checks to determine whether the value of the request status signal (REQ[i] value) identified by the enabled object detection information (i) held by the enabled object detection information holding section 216 is “1” (in step S902). If the REQ[i] value is not found to be “1,” then step S904 is reached.

If the REQ[i] value is found to be “1” (in step S902), then a check is made to determine whether the value of the enable status signal (ACK[i] value) for the client identified by the enabled object detection information (i) is “1” (in step S903). Step S903 is carried out by the enabled object detection information determination section 214. If the ACK[i] value is not found to be “1” (in step S903), then step S905 is reached. If in step S905 the ACK[i] value is not found to be “1,” that means the enabled object detection information (i) of the current cycle is held by the enabled object detection information holding section 216 because the next client to be enabled for the data transfer has been detected.

If the ACK[i] value is found to be “1” (in step S903), then the update information (((i+1−i₀)mod N)+i₀) generated by the update information generation section 213 is held by the enabled object detection information holding section 216 (in step S904). Step S904 is carried out by the enabled object detection information selection section 215.

Thereafter, a check is made to determine whether the enabled client detection process is to be continued (in step S905). If the enabled client detection process is set to be continued, then step S902 is reached again. In this case, the enabled object detection information holding section 216 is caused to output the enabled object detection information (i) held therein. The enabled client detection process is continued illustratively when the next cycle is reached. Bus control is terminated illustratively when the data processing apparatus 100 is switched off. Incidentally, steps S902, S903, S904 and S905 are examples of the updating steps described in the appended claims.

FIG. 6 is a flowchart showing a typical acknowledge signal supply process performed by the acknowledge signal supply unit 220 of the first embodiment of this invention.

First, all bits of the acknowledge signal (ACK) held by the acknowledge signal holding section 225 are initialized to “0” (in step S911). Step S911 is typically carried out immediately after power is applied to the data processing apparatus 100.

The acknowledge signal determination section 223 initializes a variable (j) to “0” (in step S912). The acknowledge signal determination section 223 then checks to determine whether both the value of the request status signal (REQ[j] value) from the client identified by the variable (j) and the value of the enable status signal (ACK[j] value) for the client indicated by the variable (j) are “1.” If the REQ[j] value and ACK[j] value are both found to be “1” (in step S913), then step S919 is reached. When the REQ[j] value and ACK[j] value are both found to be “1,” the acknowledge signal (ACK) of the current cycle is held by the acknowledge signal holding section 225.

If at least one of the REQ[j] value and ACK[j] value is not found to be “1” (in step S913), then a check is made to determine whether the variable (j) is the same as the maximum value of the enabled object detection information (N) (in step S914). If the variable (j) is not found to be the same as the maximum value of the enabled object detection information (N) (in step S914), then the variable (j) is incremented by “1” for an update (in step S915), before step S913 is reached again.

If the variable (j) is found to be the same as the maximum value of the enabled object detection information (N) (in step S914), then a check is made to determine whether the value of the 0th bit in the request signal (i.e., REQ[0] value) is “1” (in step S916). Step S916 is carried out by the acknowledge signal determination section 223. If the value of the 0th bit in the request signal (REQ[0] value) is found to be “1,” then the acknowledge signal in which the value of the 0th bit (ACK[0] value) is “1” is held by the acknowledge signal holding section 225 (in step S917).

If the value of the 0th bit in the request signal (REQ[0] value) is not found to be “1” (in step S916), then the update acknowledge signal generated by the acknowledge signal update value generation section 221 is held by the enabled object detection information holding section 216 (in step S918). That is, the acknowledge signal is updated to become an acknowledge signal in which the REQ[i] value is set to the ACK[i] value. Incidentally, step S918 is an example of the determining step described in the appended claims.

A check is then made to determine whether the acknowledge signal supply process is to be continued (in step S919). If the acknowledge signal supply process is set to be continued, then step S912 is reached again. In this case, the enabled object detection information holding section 216 is caused to output the acknowledge signal held therein. The acknowledge signal supply process is continued illustratively when the next cycle is reached. The acknowledge signal supply process is terminated illustratively when the data processing apparatus 100 is switched off.

According to the first embodiment, as described above, the next client to be enabled for a data transfer is detected while the current client is being enabled to carry out its data transfer. This makes it possible to improve the efficiency of data transfers.

As shown in FIG. 2, the enabled client detection unit 210 and acknowledge signal supply unit 220 can be constituted by such simple circuits as counter circuits, selector circuits, AND circuits, fixed value generation circuits, and registers.

### 2. Second Embodiment

With the first embodiment, it was shown that both read and write operations requested by the client are carried out in the same manner. As explained, however, a two-cycle wait state is needed upon changeover from a read process to a write process or vice versa in order to avoid data collision therebetween in the case where change over is carried out in two cycles from that process. Reducing this wait state contributes significantly to the efficiency of data transfers.

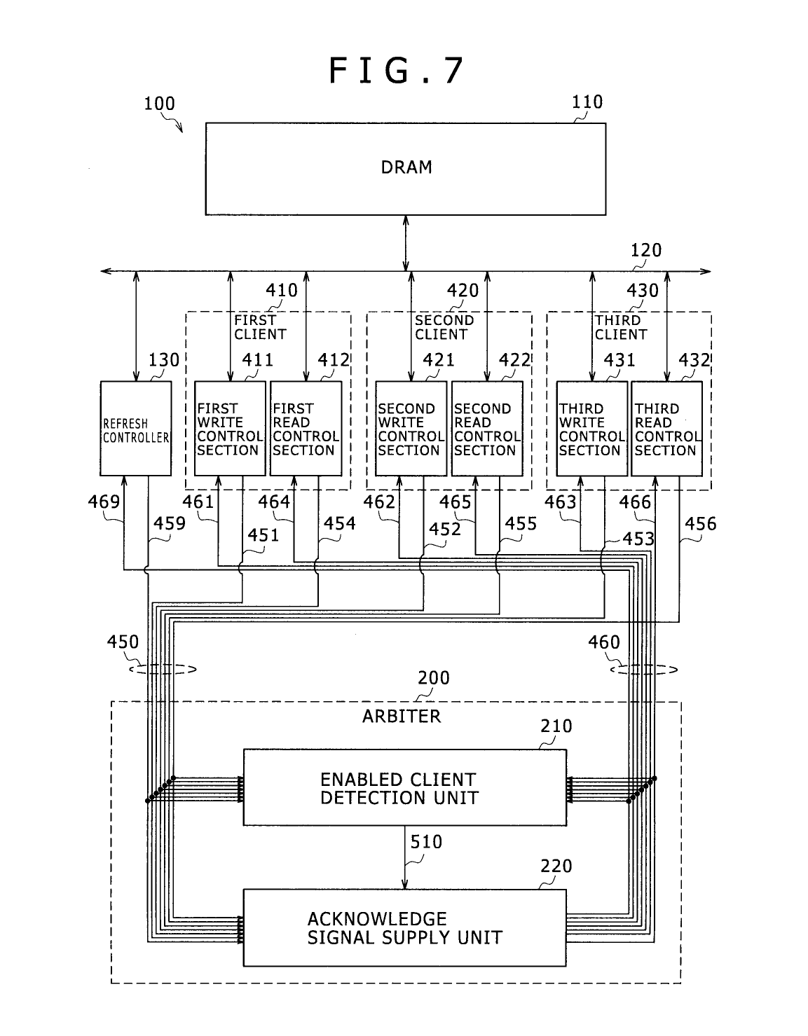

Explained below by reference to FIGS. 7 through 9 is how the changeover between data transfers to and from the DRAM 110 is alleviated by the second embodiment of this invention.

### Functional Composition Example of the Data Processing Apparatus 100

FIG. 7 is a block diagram showing a functional composition example of the data processing apparatus 100 as the second embodiment of the present invention. The data processing apparatus 100 includes a DRAM 110, a bus 120, a refresh controller 130, first through third clients 410, 420 and 430, and an arbiter 200. The components except for the first through the third clients 410, 420 and 430 are the same as those shown in FIG. 1. These components are thus designated by the same reference symbols and they will not be discussed further in detail.

For the second embodiment, the REQ[0] 159 in FIG. 1 is renamed as a REQ[0] 459 in FIG. 7 and the ACK[0] line 169 in FIG. 1 as an ACK[0] line 469 in FIG. 7. Also, the REQ lines 150 in FIG. 1 are renamed as REQ lines 450 in FIG. 7 and the ACK lines 160 in FIG. 1 as ACK lines 460 in FIG. 7 for the second embodiment.

As with the first client 141 of the first embodiment, each of the first through the third clients 410, 420 and 430 writes and reads data to and from the DRAM 110 via the bus 120. The first through the third clients 410, 420 and 430 are furnished with a first through a third write control section 411, 421 and 431, and with a first through a third read control section 412, 422 and 432, respectively.

The operations of the second and the third clients 420 and 430 are the same as those of the first client 410. Also, the operations of the second and the third write control sections 421 and 431 are the same as those of the first write control section 411. For that reason, the ensuing explanation will be focused primarily on the first write control section 411, and part of the explanations of the second and the third write control sections 421 and 431 will be omitted hereunder.

Furthermore, the operations of the second and the third read control sections 422 and 432 are the same as those of the first read control section 412. For that reason, the ensuing explanation will be focused primarily on the first read control section 412, and part of the explanations of the second and the third read control sections 422 and 432 will be omitted hereunder.

The first write control section 411 controls the write access of the first client 410. When the first client 410 needs to perform a write access operation on the DRAM 110, the first write control section 411 supplies the arbiter 200 with a signal regarding a write access request of the first client 410 via the REQ[1] line 451. The signal regarding the write access request (i.e., first write request status signal) is a one-bit signal that indicates whether or not the first client is requesting permission to perform a write access operation; this is the same signal as the request status signal in FIG. 1. From the arbiter 200, the first write control section 411 is supplied with a signal regarding permission to effect a write access operation (i.e., first write enable status signal) via the ACK[1] line 461. The first write enable status signal is a one-bit signal that indicates whether or not the first write control section 411 is enabled for a write access operation; this is the same signal as the enable status signal in FIG. 1.

The operations of the second and the third write control sections 421 and 431 are the same as those of the first write control section 411. That is, the second write control section 421 outputs the second write request status signal via the REQ[2] line 452, and the third write control section 431 sends the third write request status signal via the REQ[3] line 453. The second write control section 421 is supplied with the second write enable status signal from the arbiter 200 via the ACK[2] line 462, and the third write control section 431 is fed with the third write enable status signal also from the arbiter 200 via the ACK[3] line 463.

The first read control section 412 controls the read access of the first client 410. When the first client 410 needs to performs a read access operation on the DRAM 110, the first read control section 412 supplies the arbiter 200 with a signal regarding a read access request of the first client 410 via the REQ[4] line 454. The signal regarding the read access request (i.e., first read request status signal) is a one-bit signal that indicates whether or not the first client 410 is requesting permission to perform a read access operation; this is the same signal as the request status signal in FIG. 1. From the arbiter 200, the first read control section 412 is supplied with a signal regarding permission for a read access operation (i.e., first read enable status signal) via the ACK[4] line 464. The first read enable status signal is a one-bit signal that indicates whether or not the first read control section 412 is enabled for a read access operation; this is the same signal as the enable status signal in FIG. 1.

The operations of the second and the third read control sections 422 and 432 are the same as those of the first read control section 412. That is, the second read control section 422 outputs the second read request status signal via the REQ[5] line 455, and the third read control section 432 sends the third write request status signal via the REQ[6] line 456. From the arbiter 200, the second read control section 422 is fed with the second read enable status signal via the ACK[5] line 465. Also from the arbiter 200, the third read control section 432 is supplied with the third read enable status signal via the ACK[6] line 466.

The arbiter 200 of the second embodiment in FIG. 7 has substantially the same functionality as that of the arbiter 200 of the first embodiment in FIG. 1, with some differences therebetween in terms of the value of the enabled object detection information, the bit count of the request signal, and the bit count of the acknowledge signal, among others. These differences are explained below. With the second embodiment, there are a total of six clients to be detected: the first through the third write control sections 411, 421 and 431, and the first through the third read control sections 412, 422 and 432. For this reason, the value of the enabled object detection information with the second embodiment ranges from “1” to “6.” With regard to the DRAM 110, there are a total of seven clients: the first through the third write control sections 411, 421 and 431, the first through the third read control sections 412, 422 and 432, and the refresh controller 130. For this reason, the bit count of the request signal and that of the acknowledge signal are “7” each with the second embodiment.

In the request signal of the second embodiment, the least significant bit (LSB; 0th bit) serves as the 0th request status signal, the first bit as the first write request status signal, the second bit as the second write request status signal, the third bit as the third write request status signal, the fourth bit as the first read request status signal, the fifth bit as the second read request status signal, and the sixth bit (most significant bit (MSB)) as the third read request status signal. That is, the first through the sixth bits in the request signal each serve as the enable status signal for the client identified by the enabled object detection information.

In the acknowledge signal of the second embodiment, the least significant bit (LSB; 0th bit) serves as the 0th enable status signal, the first bit as the first write enable status signal, the second bit as the second write enable status signal, the third bit as the third write enable status signal, the fourth bit as the first read enable status signal, the fifth bit as the second read enable status signal, and the sixth bit (MSB) as the third read enable status signal. That is, the first through the sixth bits in the acknowledge signal each serve as the enable status signal for the client identified by the enabled object detection information.

When each of the clients is furnished with a write control section and a read control section as described above, these control sections can enable the corresponding client to carry out a write operation and a read operation.

### [Typical Transitions of the Values of Enabled Object Detection Information]

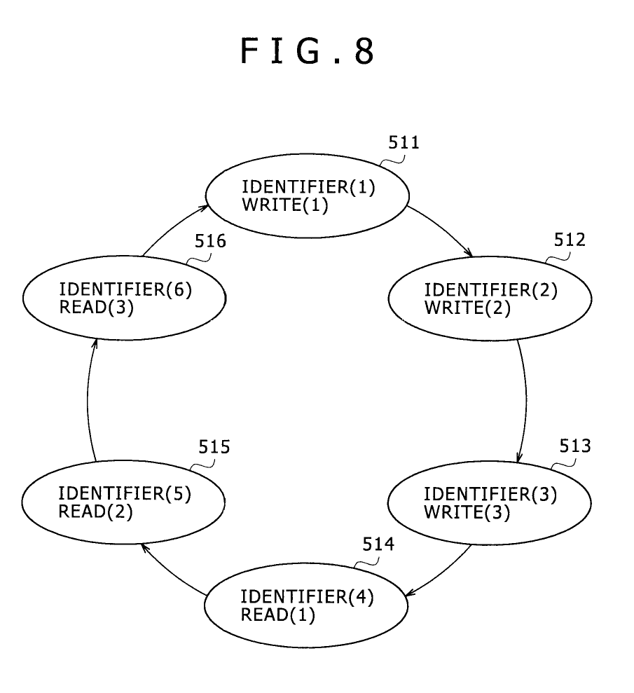

FIG. 8 is a schematic view showing typical transitions of the enabled target detection information effected by the enabled client detection unit 210 of the second embodiment of this invention. In the example of FIG. 8, the clients identified by the transitions of the enabled object detection information are indicated in ellipses 511 through 516. In each of the ellipses 511 through 516, the identifier (one of (1) through (6)) of a client and the name (one of WRITE(1) through WRITE(3) and of READ(1) through READ(3)) of that client are shown in combination. More specifically, the client corresponding to the ellipse 511 is the first write control section 411 (with identifier (1), named WRITE(1)); the client corresponding to the ellipse 512 is the second write control section 421 (with identifier (2), named WRITE(2)); the client corresponding to the ellipse 513 is the third write control section 431 (with identifier (3), named WRITE(3)); the client corresponding to the ellipse 514 is the first read control section 412 (with identifier (4), named READ(1)); the client corresponding to the ellipse 515 is the second read control section 422 (with identifier (5), named READ(2)); and the client corresponding to the ellipse 516 is the third read control section 432 (with identifier (6), named READ(3)).

In FIG. 8, the sequence of the transitions of the enabled object detection information is indicated by arrows connecting the ellipses 511 through 516. That is, the value of the enabled object detection information in FIG. 8 is shown incremented by “1” per transition up to “6.” After the count “6,” the value is shown returned to “1.”

As described, the enabled object detection information is established in such a manner that while a plurality of data transfer requests are being fed to the arbiter 200, the clients performing the same operation consisting of either a read or a write are selected consecutively. This structure suppresses the wait time occurring upon changeover between access operations, thus improving the efficiency of bus use.

### [How Acknowledge Signals are Typically Generated by the Acknowledge Signal Supply Unit]

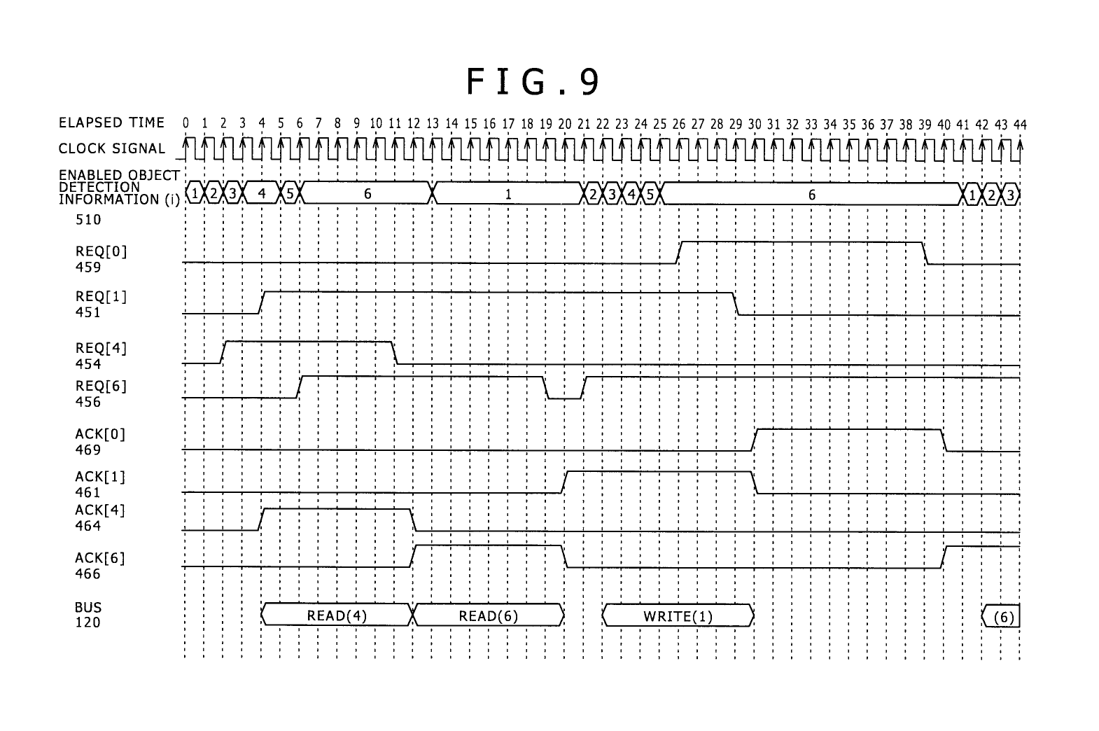

FIG. 9 is a timing chart showing how acknowledge signals are typically generated by the acknowledge signal supply unit 220 of the second embodiment of this invention.

In FIG. 9, the horizontal axis denotes the values of enabled object detection information (i) 510, the changes of the 0th request status signal on the REQ[0] line 459, and the changes of the first write request status signal on the REQ[1] line 451 relative to the clock signal being output during the operation of the arbiter 200. Also shown in this timing chart are the changes of the first read request status signal on the REQ[4] line 454, the changes of the third read request status signal on the REQ[6] line 456, and the changes of the 0th enable status signal on the ACK[0] line 469. Further indicated in this timing chart are the changes of the first write enable status signal on the ACK[1] line 461, the changes of the first read request status signal on the ACK[4] line 464, and the changes of the third read enable status signal on the ACK[6] line 466, together with read data and write data transferred via the bus 120.

For purposes of simplification and illustration in FIG. 9, the values on the REQ[2] line 452, REQ[3] line 453, and REQ[5] line 455 are assumed to be “0” each. These lines and their values are not shown in FIG. 9 and will not be discussed further. Likewise, the values on the ACK[2] line 462, ACK[3] line 463, and ACK[5] line 465 are assumed to be “0” each. These lines and their values are also not shown in FIG. 9 and will not be described further.

In FIG. 9, it is assumed that the value of the 0th request status signal on the REQ[0] line 459 is changed from “0” to “1” at the elapsed time “26” and that the value of the first write request status signal on the REQ[1] line 451 is changed from “0” to “1” at the elapsed time “4.” It is also assumed that the first read request status signal on the REQ[4] line 454 is changed from “0” to “1” at the elapsed time “2” and that the third read request status signal on the REQ[6] line 456 is changed from “0” to “1” at the elapsed times “6” and “21.”

Furthermore, it is assumed that the value of the enabled object detection information at the elapsed time “0” is “1” and that all seven bits making up the acknowledge signal are “0.” The conditions regarding data transfers via the bus 120 are assumed to be the same as those applicable to FIG. 4.

The operations of the enabled client detection unit 210 and of the acknowledge signal supply unit 220 are the same as those explained with reference to FIG. 3, with some changes in the values of the signals involved. Thus these operations will not be discussed further.

What follows is an explanation of the data transferred by the second embodiment via the bus 120 with emphasis on the use of the bus 120 as shown in FIG. 9. Between the elapsed time “4” and the elapsed time “11,” the first read control section 412 transfers a read access command to the DRAM 110 and the read data retrieved from the DRAM 110 is transferred therefrom. From the elapsed time “12” up to the elapsed time “19,” the third read control section 432 transfers a read access command to the DRAM 110 and the read data retrieved from the DRAM 110 is transferred therefrom.

Then at the elapsed times “20” and “21,” a wait time occurs to allow the first write control section 411 to transfer a write access command to the DRAM 110 in a manner averting the conflict with the immediately preceding read access operation over bus use. Between the elapsed time “22” and the elapsed time “29,” the first write control section 411 transfers the write access command to the DRAM 110 and the write data to be written to the DRAM 110 is transferred thereto.

At the elapsed times “30” and “31,” a wait time occurs to allow the refresh controller 130 to transfer a refresh command to the DRAM 110 in a manner averting the conflict with the immediately preceding write access operation over bus use. Then between the elapsed time “32” and the elapsed time “39,” the refresh controller 130 transfers the refresh command to the DRAM 110, whereby the DRAM 110 is refreshed.

With the second embodiment, as described above, the enabled object detection information is established in such a manner that the clients performing the same operation consisting of either a read or a write are selected consecutively. This structure enhances the efficiency of data transfers.

Described below are the major differences between the second embodiment and the first embodiment of this invention. With the second embodiment, the value of the signal requesting permission for a data transfer is changed from “0” to “1” first by the first read control section 412, followed by the first write control section 411 and by the third read control section 432, in that order. That is, a read access request, a write access request, and a read access request take place in that order in the request sequence. This sequence is the same as that of the requests with the first embodiment in FIG. 3.

As opposed to the request sequence above, in the data transfer sequence of the second embodiment, a read access operation of the first read control section 412 occurs first, followed by a read access operation of the third read control section 432 and a write access operation of the first write control section 411, in that order. This sequence is different from the sequence with the first embodiment in which a read access operation comes first, followed by a write access operation and a read access operation, in that order. That is, the second embodiment allows the read access operations to take place consecutively so as to reduce the wait time occurring upon changeover between access operations.

As described, the enabled object detection information is established in such a manner that the same type of data access operations is carried out consecutively. This makes it possible to reduce the wait time upon changeover between access operations. That is, the larger the number of access operations of the same type carried out continuously, the higher the efficiency with which the bus is used.

For the first and the second embodiments of this invention, the value of the enabled object detection information is assumed to be smaller than the number of cycles (i.e., eight) making up the period in which data is transferred (data transfer period). In other words, the first and the second embodiments of the present invention are each assumed to be an apparatus for which the value of the enabled object detection information is relatively small. However, depending on the number of the clients configured, there may be relatively large values of the enabled object detection information. The larger the value of the enabled object detection information, the longer the potential delay in data transfers due to a longer time period demanded to update the value of the enabled object detection information.

What follows is an explanation of typical delays that may occur in data transfers where values of the enabled object detection information are relatively large.

### [Typical Transitions of the Values of Enabled Object Detection Information in a Representative Example]

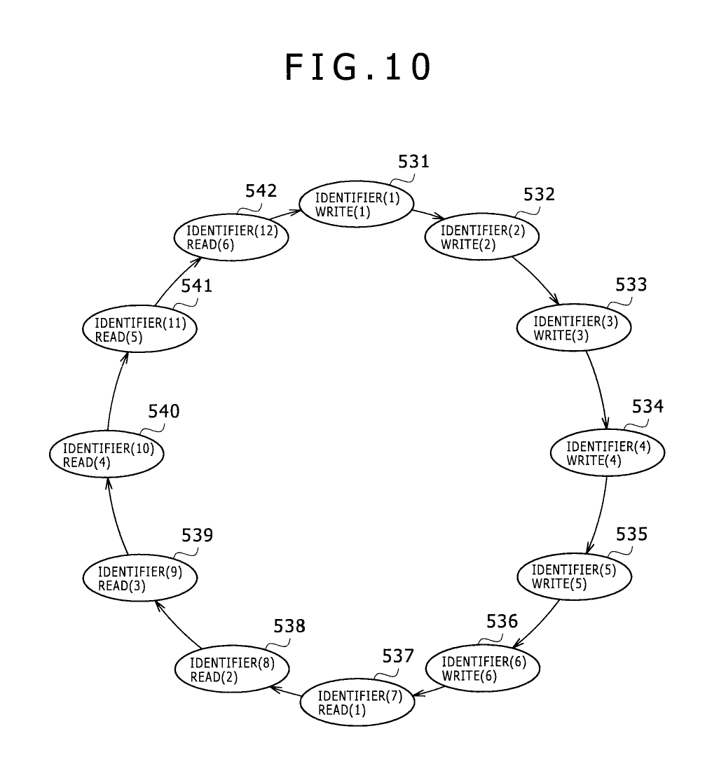

FIG. 10 is a schematic view showing typical transitions of enabled object detection information in effect where there exist large values of the enabled object detection information.

Regarding this case involving large values of the enabled object detection information, it is assumed that the data transfer period is eight cycles long and that the value of the enabled object detection information ranges from “1” to “12.” In this context, the second embodiment is assumed to have large values of the enabled object detection information. In this case, the data processing apparatus 100 is furnished respectively with a first through a sixth client replacing the first through the third clients 410, 420 and 430 in FIG. 7. Correspondingly, the first through the sixth clients are provided respectively with a first through a sixth write control section (named WRITE(1) through WRITE(6)) and with a first through a sixth read control section (named READ(1) through READ(6)).

In the example of FIG. 10, the clients identified by the transitions of the enabled object detection information are indicated in ellipses 531 through 542. In each of the ellipses 531 through 542, the identifier (one of (1) through (12)) of a client and the name (one of WRITE(1) through WRITE(6) and of READ(1) through READ(6)) of that client are shown in combination.

In FIG. 10, the sequence of the transitions of the enabled object detection information is indicated by arrows connecting the ellipses 531 through 542. That is, the value of the enabled object detection information in FIG. 10 is shown incremented by “1” per transition up to “12.” After the count “12,” the value is shown returned to “1.”

### [How Acknowledge Signals are Typically Generated by the Acknowledge Signal Supply Unit]

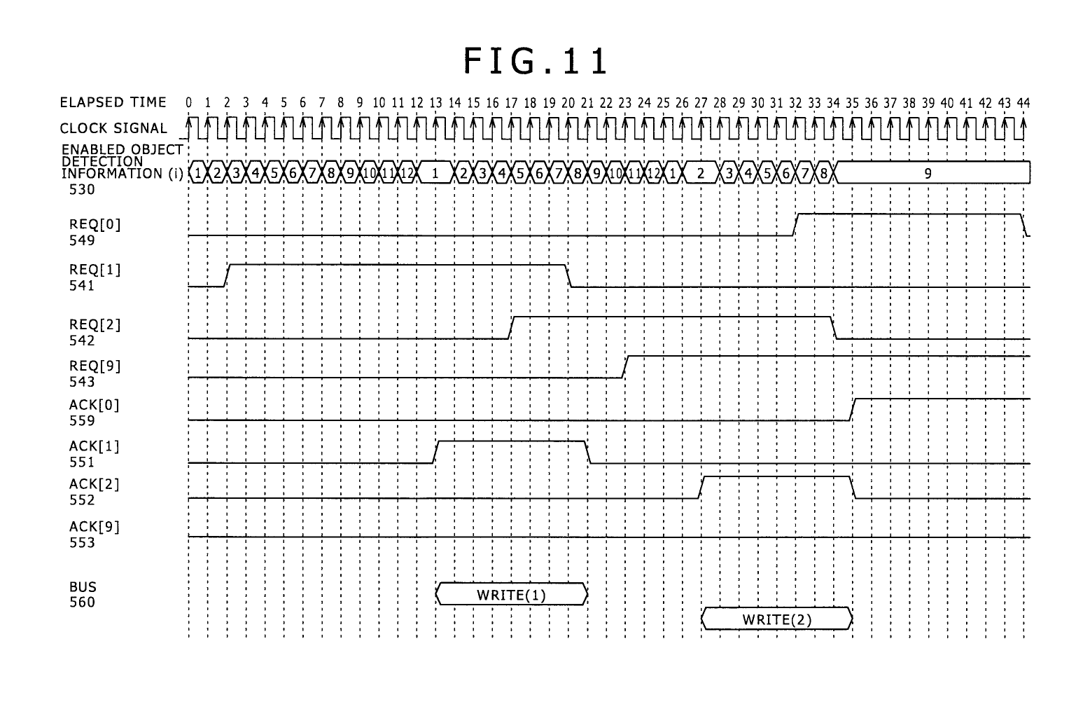

FIG. 11 is a timing chart showing how acknowledge signals are typically generated by the acknowledge signal supply unit 220 where there exist large values of the enabled object detection information.

In the ensuing description, the signals supplied from the first through the sixth write control sections (named WRITE(1) through WRITE(6)) requesting permission for write access operations will be indicated as the first through the sixth write request status signals; the signals fed from the first through the sixth read control sections (named READ(1) through READ(6)) requesting permission for read access operations will be given as the first through the sixth read request status signals; the signals sent to the first through the sixth write control sections (WRITE(1) through WRITE(6)) regarding permission for write access operations will be indicated as the first through the sixth write enable status signals; and the signals supplied to the first through the sixth read control sections (READ(1) through READ(6)) regarding permission for read access operations will be shown as the first through the sixth read enable status signal.

Also in the ensuing description, a REQ[0] line 549 will be shown to be a line that supplies the arbiter 200 with the 0th request status signal from the refresh controller 130, and an ACK[0] line 559 will be shown to be a line used by the arbiter 200 to send the 0th enable status signal to the refresh controller 130. Likewise, a REQ[1] line 541 and an ACK[1] line 551 will be shown to carry, respectively, the first write request status signal and the first write enable status signal regarding the first write control section. A REQ[2] line 542 and an ACK[2] line 552 will be shown to function likewise regarding the second write control section, and so will be a REQ[9] line 543 and an ACK[9] line 553 regarding the third read control section.

In the ensuing description, the relations between each bit in the 13-bit request signal and acknowledge signal and the corresponding enable status signal are assumed to be the same as those with the second embodiment of this invention. That is, the least significant bit (LSB; 0th bit) corresponds to the 0th enable status signal, and each of the first through the 12th bits corresponds to the enable status signal for the client identified by the corresponding value of the enabled object detection information.

In FIG. 11, the horizontal axis denotes the values of enabled object detection information (i) 530, the changes of the 0th request status signal on the REQ[0] line 549, and the changes of the first write request status signal on the REQ[1] line 541 relative to the clock signal being output during the operation of the arbiter 200. Also shown in this timing chart are the changes of the second write request status signal on the REQ[2] line 542, the changes of the third read request status signal on the REQ[9] line 543, and the changes of the 0th enable status signal on the ACK[0] line 559. Further indicated in this timing chart are the changes of the first write enable status signal on the ACK[1] line 551, the changes of the second write enable status signal on the ACK[2] line 552, and the changes of the third read enable status signal on the ACK[9] line 553, together with read data and write data transferred via a bus 560.

Also in FIG. 11, it is assumed that the 0th request status signal on the REQ[0] line 549 is changed from “0” to “1” at the elapsed time “32” and that the first write request status signal on the REQ[1] line 541 is changed from “0” to “1” at the elapsed time “2.” It is further assumed that the second write request status signal on the REQ[2] line 542 is changed from “0” to “1” at the elapsed time “17” and that the third read request status signal on the REQ[9] line 543 is changed from “0” to “1” at the elapsed time “23.”

The operations of the enabled client detection unit 210 and of the acknowledge signal supply unit 220 are the same as those explained with reference to FIG. 3, with some changes in the values of the signals involved. Thus these operations will not be discussed further.

Explained below in reference to the bus 560 in FIG. 11 is the case where the value of enabled object detection information is larger than the number of the cycles making up the data transfer period during which data is transferred via the bus 560. Between the elapsed time “13” and the elapsed time “20,” the first write control section transfers a write access command to the DRAM 110 and the write data to be written to the DRAM 110 is transferred thereto. From the elapsed time “27” up to the elapsed time “34,” the second write control section transfers a write access command to the DRAM 110 and the write data to be written to the DRAM 110 is transferred thereto.

At the elapsed times “35” and “36,” a wait time occurs to allow the refresh controller 130 to transfer a refresh command to the DRAM 110 in a manner averting the conflict with the immediately preceding write access operation over bus use. Then between the elapsed time “37” and the elapsed time “43,” the refresh controller 130 transfers the refresh command to the DRAM 110, whereby the DRAM 110 is refreshed.

What follows is an explanation of how delays occur in data transfers where the value of the enabled object detection information is relatively large. From the time the first write request status signal is changed from “0” to “1” at the elapsed time “2” until the data transfer is started at the elapsed time “13,” a total of 11 cycles elapses. This is because the first write request status signal is changed from “0” to “1” when the value of the enabled object detection information is “3,” so that a wait time of 11 cycles takes place until the value of the enabled object detection information becomes “2.” That is, the larger the value of the enabled object detection information, the longer it takes for the value of the enabled object detection information to come back to where it started.

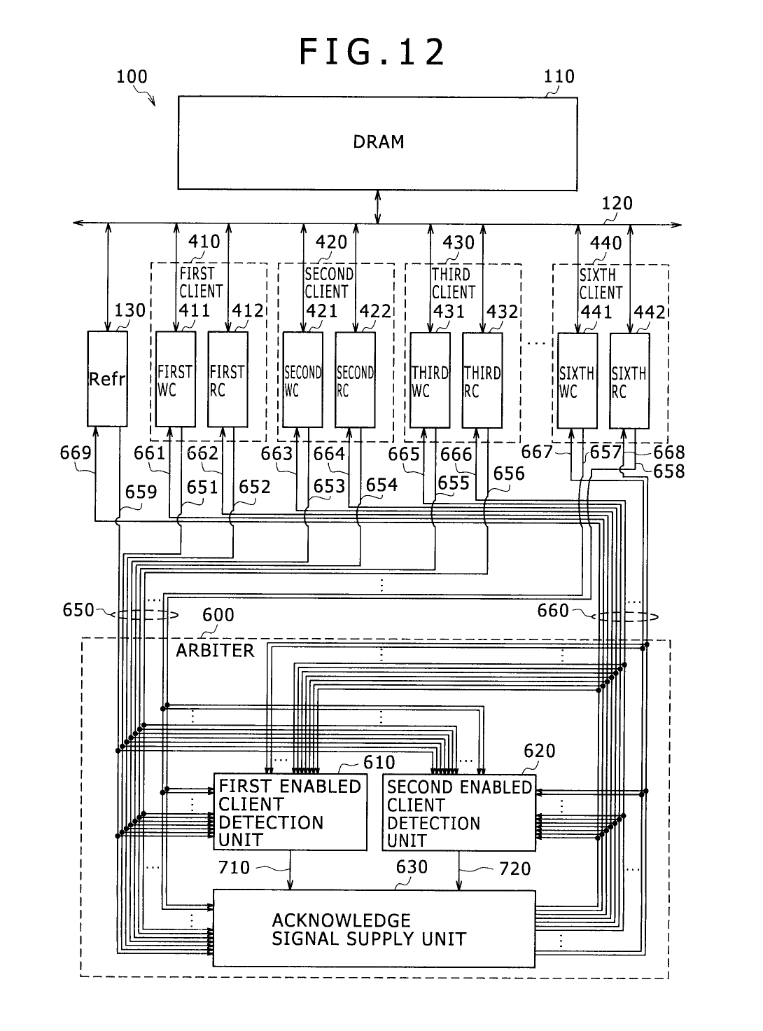

With the first and the second embodiments of this invention, as described above, delays can occur in data transfers when the value of the enabled object detection information is relatively large. Such delays will be reduced by a third embodiment of the invention, to be described below by reference to FIGS. 12 through 20.

### 3. Third Embodiment

### Functional Composition Example of the Data Processing Apparatus

FIG. 12 is a block diagram showing a functional composition example of the data processing apparatus 100 as the third embodiment of the present invention. This data processing apparatus 100 includes a DRAM 110, a bus 120, a refresh controller (Refr) 130, a first through a sixth client (1st C through 6th C) 410, 420, 430 and 440, and an arbiter 600.

The DRAM 110, bus 120, and refresh controller (Refr) 130 have the same structures as those of their counterparts in FIG. 1. These components are thus designated by the same reference symbols and their detailed descriptions will not be repeated further. The first through the sixth clients (1st C through 6th C) 410, 420, 430 and 440 have the same structure as that of the first client 410 in FIG. 7 and therefore their detailed descriptions will not be repeated further. Also, the first through the sixth write control sections (1st WC through 6th WC) 411, 421, 431 and 441 have the same structure as that of the first write control section 411 in FIG. 7 and their detailed descriptions will not be repeated hereunder. Furthermore, the first through the sixth read control sections (1st RC through 6th RC) 412, 422, 432, and 442 have the same structure as that of the first read control section 412 in FIG. 7 and thus their detailed descriptions will not be repeated hereunder.

With the third embodiment of this invention, the first through the sixth write control sections (1st WC through 6th WC) 411, 421, 431 and 441 are said to be the clients of group 1. The first through the sixth read control sections (1st RC through 6th RC) 412, 422, 432 and 442 are said to be the clients of group 2.

It is assumed that identifiers “1” through “6” identify the first through the sixth write control sections (1st WC through 6th WC) 411, 421, 431 and 441, and that identifiers “7” through “12” identify the first through the sixth read control sections (1st RC through 6th RC) 412, 422, 432 and 442.

As with the arbiter 200 in FIG. 1, the arbiter 600 is an access control section that controls each client gaining access to the DRAM 110 via the bus 120. The arbiter 600 includes a first enabled client detection unit 610, a second enabled client detection unit 620, and an acknowledge signal supply unit 630.

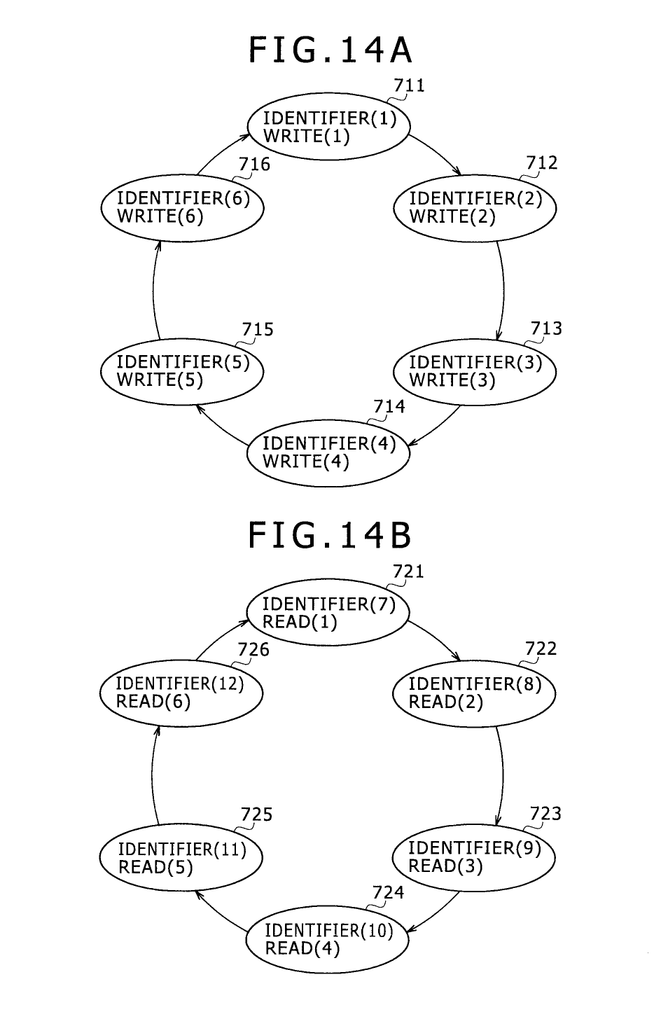

As with the enabled client detection unit 210 in FIG. 1, the first and the second enabled client detection units 610 and 620 detect the next client to be enabled for a data transfer. The first enabled client detection unit 610 holds the enabled object detection information that designates the identifiers “1” through “6” identifying the clients of group 1 (i.e., the information is called the group 1 enabled object detection information). The second enabled client detection unit 620 holds the enabled object detection information that designates the identifiers “7” through “12” identifying the clients of group 2 (i.e., group 2 enabled object detection information). That is, with the third embodiment, the first enabled client detection unit 610 holds the enabled object detection information having the values ranging from “1” to “6,” and the second enabled client detection unit 620 holds the enabled object detection formation having the values ranging from “7” to “12.” The first enabled client detection unit 610 supplies the group 1 enabled object detection information to the acknowledge signal supply unit 630 via a signal line 710. The second enabled client detection unit 620 feeds the group 2 enabled object detection information to the acknowledge signal supply unit 630 via a signal line 720. The enabled object detection information retained by the first and the second enabled client detection units 610 and 620 will be discussed later by reference to FIGS. 14A and 14B.

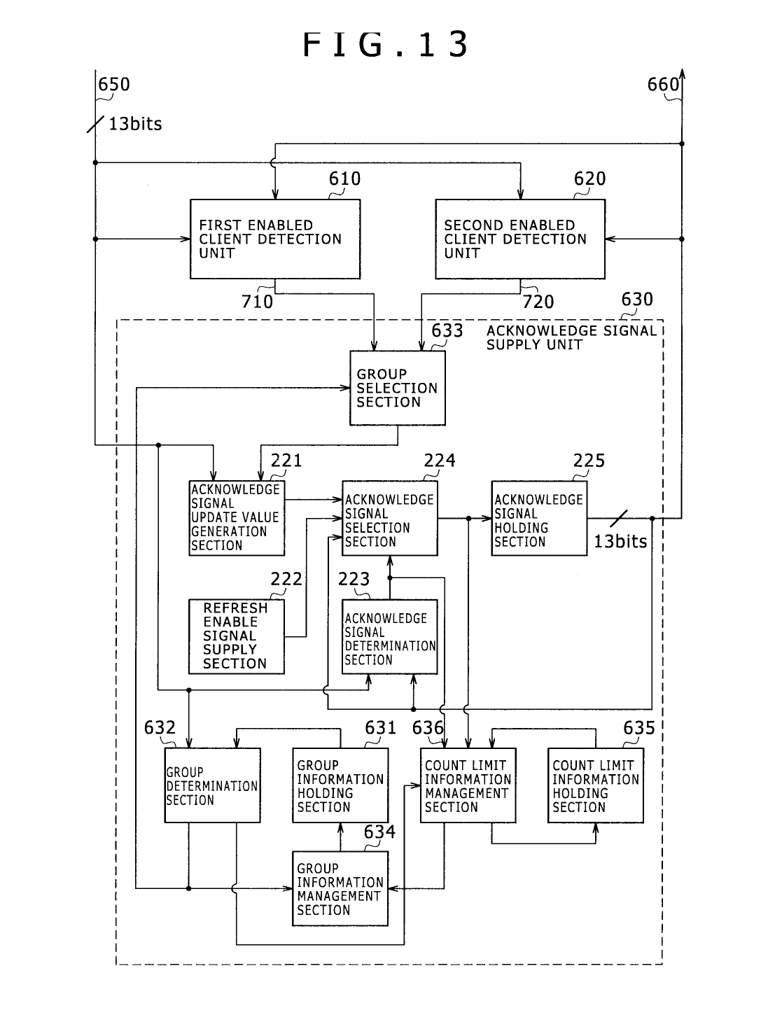

The acknowledge signal supply unit 630, as with the acknowledge signal supply unit 220 in FIG. 1, determines which of the clients requesting permission for a data transfer should be enabled to perform the data transfer. The acknowledge signal supply unit 630 generates the acknowledge signal based on ether the group 1 enabled object detection information or the group 2 enabled object detection information and on the request signal. The bits making up the generated acknowledge signal are supplied by the acknowledge signal supply unit 630 individually to the respective clients through the ACK line 660. The acknowledge signal supply unit 630 will be discussed later in more detail by reference to FIG. 13.

Where a plurality of enabled client detection units are provided as described above, multiple clients can be classified into a plurality of groups. This makes it possible to reduce the number of clients in each group and diminish the value of the enabled object detection information per group.

Although the third embodiment was shown above to have two enabled client detection units, i.e., the first and the second enabled client detection units 610 and 620, this is not limitative of the present invention. With the third embodiment, the larger the number of enabled client detection units provided, the smaller the number of the enabled object detection information allotted to each group. Illustratively, four enabled object detection sections may be furnished so as to classify the configured clients into four groups, and the number of the enabled object detection information may be set to “4” per group.

### Functional Composition Example of the Acknowledge Signal Supply Unit

FIG. 13 is a block diagram showing a functional composition example of the acknowledge signal supply unit 630 of the third embodiment of this invention. The acknowledge signal supply unit 630 includes an acknowledge signal update value generation section 221, a refresh enable signal supply section 222, an acknowledge signal determination section 223, an acknowledge signal selection section 224, and an acknowledge signal holding section 225. The acknowledge signal supply unit 630 further includes a group information holding section 631, a group determination section 632, a group selection section 633, a group information management section 634, a count limit information holding section 635, and a count limit information management section 636.

The acknowledge signal update value generation section 221, refresh enable signal supply section 222, and acknowledge signal determination section 223 are structured the same as their counterparts in FIG. 1. These components are thus designated by the same reference symbols and will not be discussed further. Also, the acknowledge signal selection section 224 and acknowledge signal holding section 225 are structured the same as their counterparts in FIG. 1. These components are thus designated by the same reference symbols and will not be described further.

The group information holding section 631 holds group information for determining which of the group 1 enabled object detection information and group 2 enabled object detection information should be fed to the acknowledge signal update value generation section 221. The group information with the value “1” denotes the group 1 enabled object detection information, and the group information with the value “2” represents the group 2 enabled object detection information. The group information holding section 631 sends the group information it retains to the group determination section 632.

Based on the group information and on the request signal, the group determination section 632 determines which of the group 1 enabled object detection information and group 2 enabled object detection information should be fed to the acknowledge signal update value generation section 221. On the basis of the request signal given via a REQ line 650, the group determination section 632 determines whether or not to change the value of the group information supplied from the group information holding section 631 and outputs the resulting group information. If the value of the request status signal from any one client belonging to the group identified by the group information coming from the group information holding section 631 is “1,” the group determination section 632 will not change the value of the group information. If the values of the request status signals from all clients belonging to the group identified by the group information coming from the group information holding section 631 are “0,” then the group determination section 632 changes the value of the group information. In determining whether or not to change the value of the group information, the group determination section 632 checks the value of the 0th bit in the supplied request signal. If the supplied request signal is found to have its 0th bit set to “1,” then the group determination section 632 will not change the value of the group information.

If it is determined that the value of the group information should remain unchanged, the group determination section 632 sends the group information of the same value as that given by the group information holding section 631 to the group selection section 633 and group information management section 634. If it is determined that the value of the group information is to be changed, then the group determination section 632 sends the group information whose value is changed from what was given by the group information holding section 631, to the group selection information 633 and to the group information management section 634. After determining to change the value of the group information, the group determination section 632 supplies update-related information (i.e., group update notification information) to the count limit management section 636.

For example, suppose that the group information with the value “1” (i.e., group information “1”) is supplied and that a request signal in which the enable request signal of any one client belonging to group 1 is “1” is given. In this case, the group determination section 632 supplies the group information “1” without changing its value. If the group information “1” is supplied and if a request signal in which the enable request signals of all clients belonging to group 1 are “0” is given, then the group information “1” is changed to “2” before being output.

Based on the group information fed from the group determination section 632, the group selection section 633 determines which of the group 1 enabled object detection information and group 2 enabled object detection information should be supplied to the acknowledge signal update value generation section 221. Illustratively, if the group information “1” is given, the group selection section 633 supplies the acknowledge signal update value generation section 221 with the group 1 enabled object detection information sent via the signal line 710. If the group information “2” is given, then the group selection section 633 supplies the acknowledge signal update value generation section 221 with the group 2 enabled object detection information sent via the signal line 720. Incidentally, the group determination section 632 and group selection section 633 are examples of the selection section described in the appended claims.

The group information management section 634 manages the group information held by the group information holding section 631 based on the group information fed from the group determination section 632 and on group update command information coming from the count limit information management section 636. In this context, the group update command information signifies information for allowing the group information management section 634 to update the group information fed from the group determination section 632 and to cause the group information holding section 631 to hold the group information with the updated value. Illustratively, if the group information “1” is supplied from the group determination section 632 and if the group update command information is not given by the count limit information management section 636, the group information management section 634 causes the group information holding section 631 to hold the group information “1.” If the group information “1” is supplied from the group determination section 632 and if the group update command information is given by the count limit information management section 636, then the group information management section 634 causes the group information holding section 631 to hold the group information “2.” The group information management section 634 supplies the group information to the group information holding section 631. Incidentally, the group information management section 634 is an example of the group update section described in the appended claims.

The count limit information holding section 635 holds information about the number of times the clients belonging to the same group can perform data transfers consecutively (hence the name “count limit information”). The count limit information holding section 635 sends the count limit information it holds to the count limit information management section 636.

The count limit information management section 636 manages the count limit information based on the acknowledge signal selected by the acknowledge signal selection section 224 and on the command sent by the acknowledge signal determination section 223 to the acknowledge signal selection section 224. Illustratively, if the acknowledge signal determination section 223 gives an ACK wait command or a first ACK update command, the count limit information management section 636 will not update the count limit information. Also, the count limit information management section 636 will not update the count limit information if the acknowledge signal determination section 223 gives a second ACK update command and if all bits of the acknowledge signal selected by the acknowledge signal determination section 224 are “0.”

If the second ACK update command is given and if any one of the bits in the acknowledge signal selected by the acknowledge signal selection section 224 is “1,” the count limit information management section 636 checks to determine whether the value of the count limit information is “1.” If the value of the count limit information is not “1,” then the count limit information management section 636 updates the count limit information by subtracting “1” from the value of that information. If the value of the count limit information is “1,” that means this is the last time a client of the same group can consecutively perform its data transfer. Thus if the value of the count limit information is found to be “1,” then the count limit information management section 636 supplies the group update command information and simultaneously updates the value of the count limit information to a maximum value applicable to the group in question. The count limit information management section 636 causes the count limit information holding section 635 to hold the count limit information regarding which update management has been completed.

When the group information and the count limit information are utilized as described above, it is possible to enable one of a plurality of clients requesting permission for data transfers to carry out the data transfer through the use of a plurality of pieces of enabled object detection information.

### [Typical Transitions of the Values of Enabled Target Detection Information]

FIGS. 14A and 14B are schematic views showing typical transitions of enabled target detection information for the third embodiment of this invention.

In. FIG. 14A, the clients identified by the transitions of the group 1 enabled object detection information held in the first enabled client detection unit 610 are indicated in ellipses 711 through 716. In each of the ellipses 711 through 716, the identifier (one of (1) through (6)) of a client and the name (one of WRITE(1) through WRITE(6)) of that client are shown in combination. In FIG. 14A, the sequence of the transitions of the group 1 enabled object detection information is indicated by arrows connecting the ellipses 711 through 716. That is, the value of the group 1 enabled object detection information in FIG. 14A is shown incremented by “1” per transition up to “6.” After the count “6,” the value is shown returned to “1.”

In. FIG. 14B, the clients identified by the transitions of the group 2 enabled object detection information held in the second enabled client detection unit 620 are indicated in ellipses 721 through 726. In each of the ellipses 721 through 726, the identifier (one of (7) through (12)) of a client and the name (one of READ(1) through READ(6)) of that client are shown in combination. In FIG. 14B, the sequence of the transitions of the group 2 enabled object detection information is indicated by arrows connecting the ellipses 721 through 726. That is, the value of the group 2 enabled object detection information in FIG. 14B is shown incremented by “1” per transition up to “12.” After the count “12,” the value is shown returned to “7.”

As described, the configured clients are classified into a group of those performing the read operation and a group of those carrying out the write operation. The clients to be enabled for data transfers are detected per group, so that the values of the enabled object detection for each group may be reduced.

For the third embodiment discussed above, the clients were shown classified into groups by access type. However, this is not limitative of the present invention. For the third embodiment, the clients may be grouped by any other suitable criterion as long as the values of the enabled object detection information per group are made smaller than those before the grouping. For example, the first through the sixth clients 141 through 147 of the first embodiment shown in FIG. 1 may be classified into two groups.

For the third embodiment above, the clients were shown classified into groups in such a manner that any one client will not belong to a plurality of groups. However, this is not limitative of the present invention. Alternatively, a particular client may be classified into multiple groups. This makes it possible to supply the enabled object detection information about that client to the acknowledge signal supply unit 630 more frequently than that information about the other clients.

### [How Acknowledge Signals are Typically Generated by the Acknowledge Signal Supply Unit]

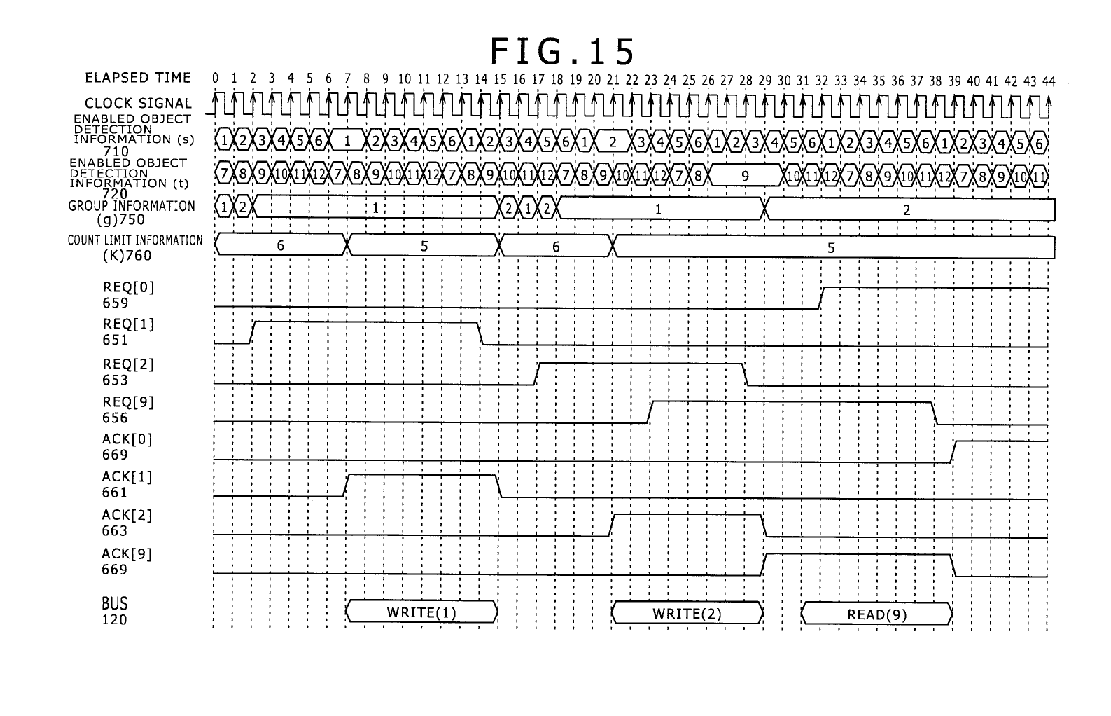

FIG. 15 is a timing chart showing how acknowledge signals are typically generated by the acknowledge signal supply unit 630 of the third embodiment of this invention. For the third embodiment, a variable “s” is assumed to represent the enabled object detection information “1” to “6” held by the first enabled client detection unit 610 (i.e., group 1 enabled object detection information), and a variable “t” is assumed to denote the enabled object detection information “7” to “12” held by the second enabled client detection unit 620 (group 2 enabled object detection information). It is also assumed that a variable “g” represents the group information fed from the group information holding section 631 and that a variable “k” stands for the count limit information supplied from the count limit information holding section 635.

Furthermore, it is assumed for the third embodiment that the maximum value of the count limit information regarding group 1 is “6” and that the maximum value of the count limit information regarding group 2 is also “6.”

The relations between REQ[0] through REQ[9] lines 659, 651, 653 and 656 on the one hand and the clients on the other hand are the same as those discussed above in conjunction with the REQ[0] through REQ[9] lines 549, 541, 542 and 543 in FIG. 11, and thus will not be described further. Also, the relations between ACK[0] through ACK[9] lines 669, 661, 663 and 669 on the one hand and the clients on the other hand are the same as those explained above in connection with the ACK[0] through ACK[9] lines 559, 551, 552 and 553, and thus will not be described further.

It is assumed that with the third embodiment, the individual bits making up the 13-bit request signal and acknowledge signal are related to the corresponding enable status signals in the same manner as with the second embodiment of the invention. That is, the least significant bit (LSB; 0th bit) is the 0th enable status signal, and each of the first through the 12th bits represents the enable status signal from the client identified by the enabled object detection information.

In FIG. 15, the horizontal axis denotes the values of group 1 enabled object detection information (s) 710, the values of group 2 enabled object detection information (t) 720, the values of group information (g) 750, and the values of count limit information (k) 760 relative to the clock signal being output during the operation of the arbiter 200. Also shown in this timing chart are the changes of the 0th request status signal on the REQ[0] line 659, the changes of the first write request status signal on the REQ[1] line 651, and the changes of the second write request signal on the REQ[2] line 653. Further shown in this timing chart are the changes of the third read request status signal on the REQ[9] line 656, the changes of the 0th enable status signal on the ACK[0] line 669, and the changes of the first write enable status signal on the ACK[1] line 661. Also indicated in this timing chart are the changes of the second write enable status signal on the ACK[2] line 663 and the changes of the third read enable signal on the ACK[9] line 669, together with read data and write data transferred via the bus 120.

In FIG. 15, the timings for the transitions from “0” to “1” on the REQ[0] through REQ[9] lines 659, 651, 653 and 656 are the same as the timings for the transitions on the REQ[0] through REQ[9] 549, 541, 542 and 543 in FIG. 11, and thus will not be discussed further. The operations of the first enabled client detection unit 610 and of the second enabled client detection unit 620 are the same as those of the enabled client detection unit 210 in FIG. 3, with some changes in the values of the signals involved. Thus these operations will not be discussed further. Similarly, the operations of the acknowledge signal update value generation section 221 and of the refresh enable signal supply section 222 in the acknowledge signal supply unit 630 are the same as the operations of their counterparts in FIG. 3, so that these operations will not be explained further. In like manner, the operations of the acknowledge signal selection section 224, of the acknowledge signal holding section 225, and of the acknowledge signal determination section 223 in the acknowledge signal supply unit 630 are the same as the operations of their counterparts in FIG. 3, so that these operations will not be described further.

What follows is an explanation of the operations performed by the acknowledge signal supply unit 630 at the elapsed time “0.” The group information holding section 631 sends the group information “1” it holds to the group determination section 632. In turn, the group determination section 632 changes the group information from “1” to “2” because the enable request signals from all clients belonging to group 1 are “0,” and feeds the group information “2” to the group information management section 634 and group selection section 633. Also, the group determination section 632 supplies group update notification information to the count limit information management section 636.

Then the group selection section 633 selects the group 2 enabled object detection information “7” from the second enabled client detection unit 620 based on the group information “2” supplied from the group determination section 632. The group selection section 633 sends the selected group 2 enabled object detection information “7” to the acknowledge signal update value generation section 221. Based on the enabled object detection information “7” and on the request signal (in which all bits are “0”), the acknowledge signal update value generation section 221 generates an update acknowledge signal in which all bit values are “0.” Then the acknowledge signal determination section 223 and acknowledge signal selection section 224 select the update acknowledge signal and supply the selected update acknowledge signal to the acknowledge signal holding section 225 and count limit information management section 636.

Based on the group update notification information, the count limit information management section 636 updates the count limit information “6” fed from the count limit information holding section 635 to the maximum value of the count limit information for group 2. Based on the acknowledge signal (update acknowledge signal) in which all 13 bits are “0” and on the second ACK update command, the count limit information management section 636 determines not to update the count limit information and sends the count limit information “6” to the count limit information holding section 635.

The above-described operations at the elapsed time “0” determine the group information “2,” count limit information “6,” and acknowledge signal (in which all bits are “0”) for the elapsed time “2.” By carrying out the same operations as those of the enabled client detection unit 210 in FIG. 3, the first enabled client detection unit 610 determines the group 1 enabled object detection information “2” for the elapsed time “2.” The second enabled client detection unit 620 determines the group 2 enabled object detection information “8” for the elapsed time “2.”

The operations at the elapsed time “1” are the same as those at the elapsed time “0” and thus will not be described further. Determined at the elapsed time “1” are the group information “1,” count limit information “6,” acknowledge signal (in which all bits are “0”), group 1 enabled object detection information “3,” and group 2 enabled object detection information “9” for the elapsed time “2.”

At the elapsed time “2,” the value of the first write request status signal on the REQ[1] line 651 is changed from “0” to “1.” Because the first write request signal from the first write control section 411 of group 1 identified by the supplied group information “1” is “1,” the group determination section 632 does not update the group information and supplies the group information “1” to the group information management section 634 and group selection section 633.

Based on the group information “1” from the group determination section 632, the group selection section 633 then selects the group 1 enabled object detection information “3” fed from the first enabled client detection unit 610. The group selection section 633 proceeds to feed the selected group 1 enabled object detection information “3” to the acknowledge signal update value generation section 221. Given the group 1 enabled object detection information “3” and the request signal (in which the first bit alone is “1”), the acknowledge signal update value generation section 221 generates an update acknowledge signal in which all bits are “0.” The acknowledge signal determination section 223 and acknowledge signal selection section 224 then select the update acknowledge signal and send the selected signal to the acknowledge signal holding section 225 and count limit information management section 636.

Based on the acknowledge signal in which all bits are “0” (update acknowledge signal) and on the second ACK update command, the count limit information management section 636 determines not to update the count limit information “6” supplied from the count limit information holding section 635. The count limit information management section 636 proceeds to feed the count limit information “6” to the count limit information holding section 635. The above-described operations at the elapsed time “2” determine the group information “1,” count limit information “6,” and acknowledge signal (in which all bits are“0”) for the elapsed time “3.” By carrying out the same operations as those of the enabled client detection unit 210 in FIG. 9, the first enabled client detection unit 610 determines the group 1 enabled object detection information “4” for the elapsed time “3.” The second enabled client detection unit 620 determines the group 2 enabled object detection information “10” for the elapsed time “3.”

The operations of the first enabled client detection unit 610, of the second enabled client detection unit 620, and of the acknowledge signal supply unit 630 between the elapsed time “3” and the elapsed time “5” are the same as those at the elapsed time “2” and thus will not be described further.

At the elapsed time “6,” the first write request signal from the first write control section 411 identified by the group 1 enabled object detection information “1” is “1.” For that reason, the first enabled client detection unit 610 determines the value of the group 1 enabled object detection information for the elapsed time “7” to be “1.” By carrying out the same operations as those at the elapsed time “2,” the group determination section 632 and group selection section 633 select the group 1 enabled object detection information “1” sent from the first enabled client detection unit 610. The group determination section 632 and group selection section 633 proceed to supply the selected group 1 enabled object detection information “1” to the acknowledge signal update value generation section 221. Based on the enabled object detection information “1” and on the request signal (in which the first bit alone is “1”), the acknowledge signal update value generation section 221 generates an update acknowledge signal in which the first bit is “1.”

The acknowledge signal determination section 223 and acknowledge signal selection section 224 then select the update acknowledge signal and send the selected signal to the acknowledge signal holding section 225 and count limit information management section 636. Based on the acknowledge signal in which the first bit is “1” (update acknowledge signal) and on the second ACK update command, the count limit information management section 636 updates the count limit information by subtracting “1” from the count limit information “6” supplied from the count limit information holding section 635. The count limit information management section 636 supplies the count limit information holding section 635 with the count limit information “5” obtained by subtracting “1” from “6” as described.

The above-described operations at the elapsed time “6” determine the group information “1,” count limit information “5,” acknowledge signal (in which the first bit is “1”), group 1 enabled object detection information “1,” and group 2 enabled object detection information “8” for the elapsed time “7.”

At the elapsed time “7,” the group determination section 632 determines not to update the group information and supplies the group information “1” to the group information management section 634 and group selection section 633. The acknowledge signal determination section 223 and acknowledge signal selection section 224 send the acknowledge signal of the current cycle to the acknowledge signal holding section 225 and count limit information management section 636. Based on the acknowledge signal in which the first bit is “1” and on the ACK wait command, the count limit information management section 636 determines not to update the count limit information and feeds the count limit information “5” to the count limit information holding section 635. At the elapsed time “7,” as described above, the group information “1,” count limit information “5,” and acknowledge signal (in which the first bit is “1”) for the elapsed time “8” are determined.

The operations of the first enabled client detection unit 610, of the second enabled client detection unit 620, and of the acknowledge signal supply unit 630 between the elapsed time “8” and the elapsed time “27” are the same as those explained up to the elapsed time “7” and thus will not be described further.

Because the request status signals from all clients of group 1 identified by the supplied group information “1” are “0” at the elapsed time “28,” the group determination section 632 supplies the group information “2” to the group information management section 634 and group selection section 633. Also, the group determination section 632 sends group update notification information to the count limit information management section 636.

Based on the group information “2” fed from the group determination section 632, the group selection section 633 supplies the group 2 enabled object detection information “9” to the acknowledge signal update value generation section 221. Given the enabled object detection information “9” and the request signal (in which the 9th bit is “1”), the acknowledge signal update value generation section 221 generates an update acknowledge signal in which the ninth bit is “1.” The acknowledge signal determination section 223 and acknowledge signal selection section 224 then select the update acknowledge signal and feed the selected signal to the acknowledge signal holding section 225 and count limit information management section 636.

Based on the group update notification information, the count limit information management section 636 updates the count limit information “5” fed from the count limit information holding section 635 to the maximum value “6” of the count limit information for group 2. Then based on the acknowledge signal in which the ninth bit is “1” and on the second ACK update command, the count limit information management section 636 updates the count limit information by subtracting “1” from the updated count limit information “6.” The count limit information management section 636 proceeds to supply the count limit information holding section 635 with the count limit information “5” obtained by subtracting “1” from “6” as described. The above-described operations at the elapsed time “28” determine the group information “2,” count limit information “5,” and acknowledge signal (in which the 9th bit is “1”) for the elapsed time “29.”

The operations of the first enabled client detection unit 610, of the second enabled client detection unit 620, and of the acknowledge signal supply unit 630 between the elapsed time “29” and the elapsed time “37” are the same as those explained up to the elapsed time “28” and thus will not be described further.

At the elapsed time “38,” the group determination section 632 supplied with the request signal in which the 0th bit is “1” does not update the group information and sends the group information “2” to the group information management section 634 and group selection information 633. The acknowledge signal determination section 223 feeds the first ACK update command to the count limit information management section 636 while the acknowledge signal selection section 224 sends the acknowledge signal in which the 0th bit is “1” (i.e., refresh enable signal) to the acknowledge signal holding section 225 and count limit information management section 636. Given the first ACK update command, the count limit information management section 636 determines not to update the count limit information “5” coming from the count limit information holding section 635. The count limit information management section 636 then sends the count limit information “5” to the count limit information holding section 635. The above-described operations at the elapsed time “38” determine the group information “2,” count limit information “5,” and acknowledge signal (in which the 0th bit is “1”) for the elapsed time “39.”

At the elapsed time “39,” the group determination section 632 supplied with the request signal in which the 0th bit is “1” does not update the group information and sends the group information “2” to the group information management section 634 and group selection information 633. The acknowledge signal determination section 223 feeds the ACK wait command to the count limit information management section 636 while the acknowledge signal selection section 224 sends the acknowledge signal of the current cycle (in which the 0th bit is “1”) to the acknowledge signal holding section 225 and count limit information management section 636. Given the ACK wait command, the count limit information management section 636 determines not to update the count limit information “5” coming from the count limit information holding section 635. The count limit information management section 636 then sends the count limit information “5” to the count limit information holding section 635. The above-described operations at the elapsed time “39” determine the group information “2,” count limit information “5,” and acknowledge signal (in which the 0th bit is “1”) for the elapsed time “40.”

Between the elapsed time “40” and the elapsed time “43,” the operations of the first enabled client detection unit 610, of the second enabled client detection unit 620, and of the acknowledge signal supply unit 630 are the same as the operations explained up to the elapsed time “39” and thus will not be discussed further.

What follows is an explanation of the data transferred by the third embodiment via the bus 120 with emphasis on the use of the bus 120 as shown in FIG. 15. Between the elapsed time “7” and the elapsed time “14,” the first write control section 411 transfers a write access command to the DRAM 110 and the write data to be written to the DRAM 110 is transferred thereto. From the elapsed time “21” up to the elapsed time “28,” the second write control section 421 transfers a write access command to the DRAM 110 and the write data to be written to the DRAM 110 is transferred thereto.

Then at the elapsed times “29” and “30,” a wait time occurs to allow the third read control section 432 to transfer a read access command to the DRAM 110 in a manner averting the conflict with the immediately preceding write access operation over bus use. Between the elapsed time “31” and the elapsed time “38,” the third read control section 432 transfers the read access command to the DRAM 110 and the read data retrieved from the DRAM 110 is transferred therefrom.

At the elapsed times “39” and “40,” a wait time occurs to allow the refresh controller 130 to transfer a refresh command to the DRAM 110 in a manner averting the conflict with the immediately preceding read access operation over bus use. Then between the elapsed time “41” and the elapsed time “43,” the refresh controller 130 transfers the refresh command to the DRAM 110, whereby the DRAM 110 is refreshed.

Described below are the major differences in functionality between the third embodiment and the case of FIG. 11 in which one enabled client detection unit is provided and in which the value of the enabled object detection information becomes larger than the number of cycles making up the data transfer period. Between the third embodiment and the case of FIG. 11, the operations of the arbiter differ but the number of request signals and the value of the enabled object detection information are the same. In the case of FIG. 11, the first write control section performs a write access operation between the elapsed time “13” and the elapsed time “20.” With the third embodiment, the first write control section 411 carries out a write access operation between the elapsed time “7” and the elapsed time “14.” That is, under the conditions shown in FIGS. 11 and 15, the first and the second enabled client detection units 610 and 620 are provided to reduce the delay in data transfers by six cycles.

In the manner described above, the delays in data transfers can be decreased by installing a plurality of enabled client detection units.

### [Typical Operations of the Arbiter]

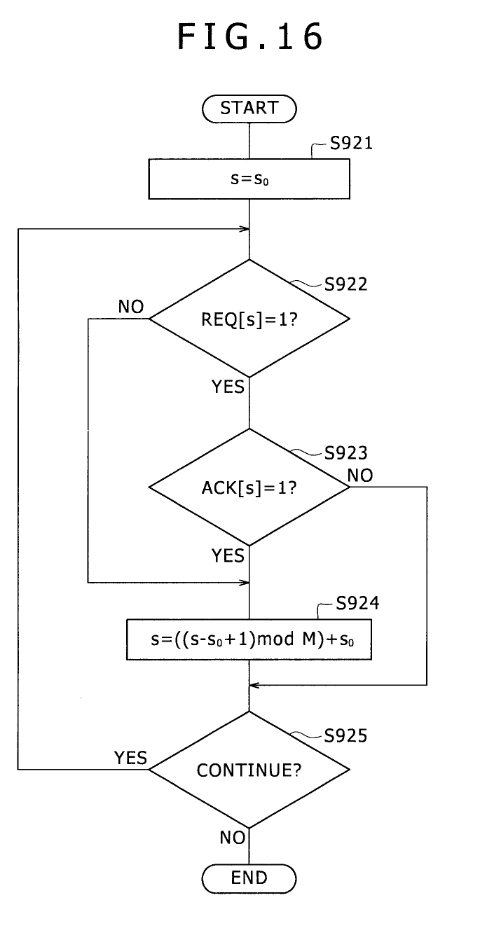

FIG. 16 is a flowchart showing a typical enabled client detection process performed by the first enabled client detection unit 610 of the third embodiment of this invention. In FIGS. 16 through 20, reference character “s” stands for the enabled object detection information (group 1 enabled object detection information) for the first enabled client detection unit 610, and “s₀” for a minimum value of the group 1 enabled object detection information. Also, a REQ[s] value denotes the value of the request status signal from the client identified by the group 1 enabled object detection information (s), and an ACK[s] value represents the value of the enable status signal supplied to the client identified by the group 1 enabled object detection information (s). Furthermore, reference character M stands for a maximum value of the group 1 enabled object detection information.

That is, with the third embodiment, the group 1 enabled object detection information (s) is given as one of the values “1” through “6”; the minimum value of the group 1 enabled object detection information (s₀) is “1”; and the maximum value of the group 1 enabled object detection information (M) is “6.”

The enabled client detection process performed by the first enabled client detection unit 610 is the same as the enabled client detection process carried out by the enabled client detection process 210 as shown in FIG. 5 and thus will not be described further. Specifically, step S921 corresponds to step S901, step S922 to step S902, step S923 to step S903, step S924 to step S904, and step S925 to step S905.

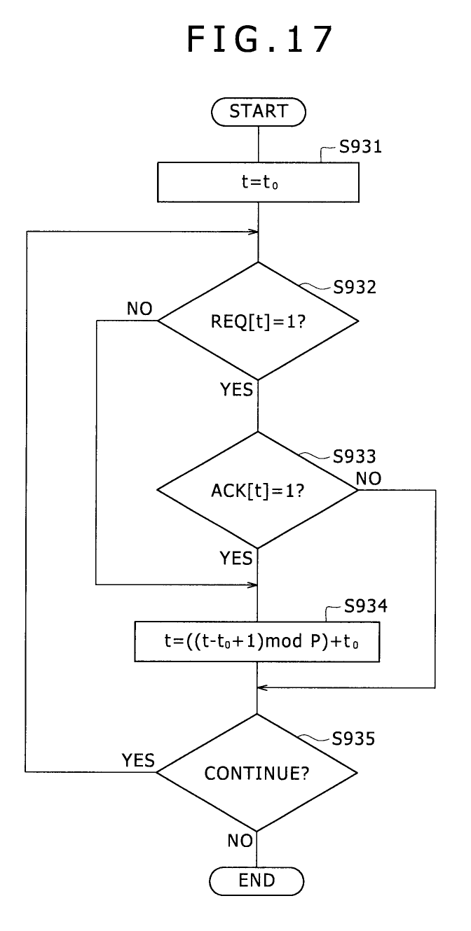

FIG. 17 is a flowchart showing a typical enabled client detection process performed by the second enabled client detection unit 620 of the third embodiment of this invention. In FIGS. 16 through 20, reference character “t” stands for the enabled object detection information (group 2 enabled object detection information) for the second enabled object detection section 620, and “t₀” for a minimum value of the group 2 enabled object detection information. Also, a REQ[t] value denotes the value of the request status signal from the client identified by the group 2 enabled object detection information (t), and an ACK[t] value represents the value of the enable status signal supplied to the client identified by the group 2 enabled object detection information (t). Furthermore, reference character P stands for a maximum value of the group 2 enabled object detection information.

That is, with the third embodiment, the group 2 enabled object detection information (t) is given as one of the values “7” through “12”; the minimum value of the group 2 enabled object detection information (t₀) is “7”; and the maximum value of the group 2 enabled object detection information (P) is “12.”

The enabled client detection process performed by the second enabled client detection unit 620 is the same as the enabled client detection process carried out by the enabled client detection process 210 as shown in FIG. 5 and thus will not be described further. Specifically, step S931 corresponds to step S901, step S932 to step S902, step S933 to step S903, step S934 to step S904, and step S935 to step S905.

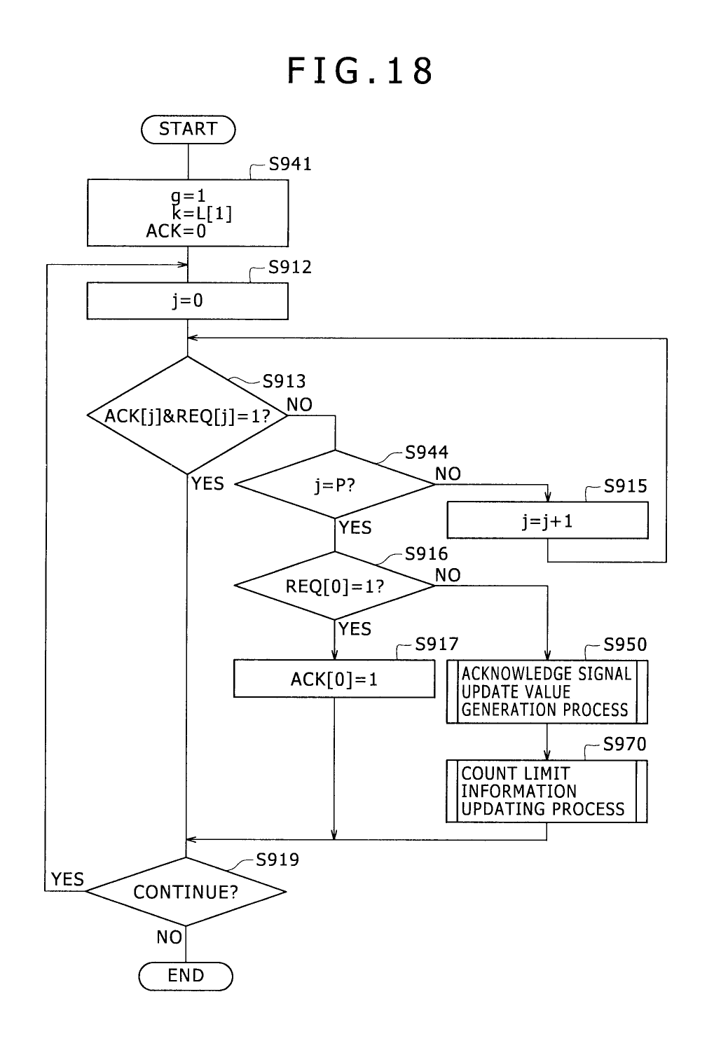

FIG. 18 is a flowchart showing a typical acknowledge signal supply process performed by the acknowledge signal supply unit 630 of the third embodiment. In FIGS. 18 through 20, reference character “g” stands for the group information held by the group information holding section 631, and “k” for the count limit information held by the count limit information holding section 635. Also, L[1] denotes a maximum value of the count limit information for group 1 (group 1 maximum count), and L[2] represents a maximum value of the count limit information for group 2 (group 2 maximum count).

That is, with the third embodiment, the group information (g) is given as one of the values “1” and “2”; the count limit information (k) is given as one of the values “1” through “6”; the group 1 maximum count L[1] is “6”; and the group 2 maximum count L[2] is “6.”

First of all, the acknowledge signal (ACK) in the acknowledge signal holding section 225, the count limit information (k) in the count limit information holding section 635, and the group information in the group information holding section 631 are initialized (in step S941). The initialization resets all bits of the acknowledge signal (ACK) to “0,” the value of the group information (g) to “1,” and the count limit information (k) to “6” that is the group 1 maximum count L[1]. Step S941 is typically carried out immediately after power is applied to the data processing apparatus 100.

The acknowledge signal determination section 223 then initializes the variable (j) to “0” (in step S912). The acknowledge signal determination section 223 checks to determine whether both the value of the request status signal (REQ[j] value) identified by the variable “j” and the value of the enable status signal (ACK[j] value) for the client identified by the variable “j” are “1” (in step S913). If both the REQ[j] value and the ACK[j] value are found to be “1” (in step S913), then control is passed on to step S919. In this case, the acknowledge signal (ACK) of the current cycle is held by the acknowledge signal holding section 225.

If at least one of the REQ[j] value and the ACK[j] value is not found to be “1” (in step S913), then a check is made to determine whether the variable (j) is the same as the maximum value of the group 2 enabled object detection information (P) (in step S944). That is, the check in step S913 determines whether the variable “j” has become the same as the maximum value of the group 1 enabled object detection information or of the group 2 enabled object detection information. If the variable (j) is not found to be the same as the maximum value of the group 2 enabled object detection information (P) (in step S944), then the variable “j” is incremented by “1” for an update (in step S915), before step S913 is reached again.

If the variable (j) is found to be the same as the maximum value of the group 2 enabled object detection information (P) (in step S944), then a check is made to determine whether the 0th bit of the request signal (REQ[0] value) is “1” (in step S916). Step S916 is carried out by the acknowledge signal determination section 223. If the 0th bit of the request signal (REQ[0] value) is found to be “1” (in step S916), then the acknowledge signal in which the 0th bit (ACK[0] value) is “1” is held by the acknowledge signal holding section 225 (in step S917).

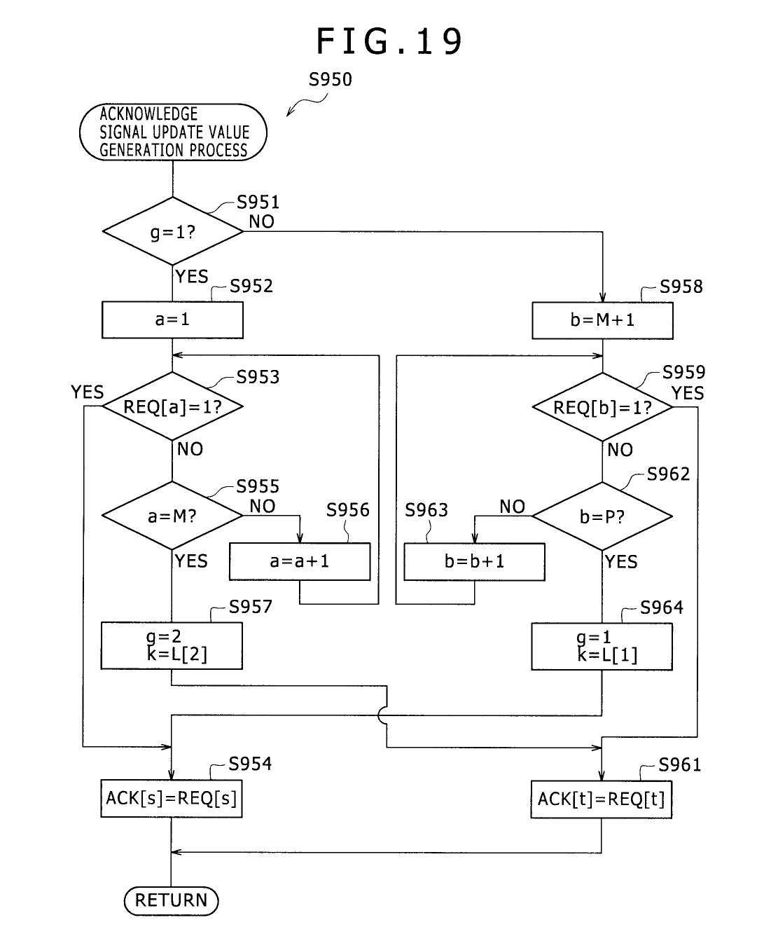

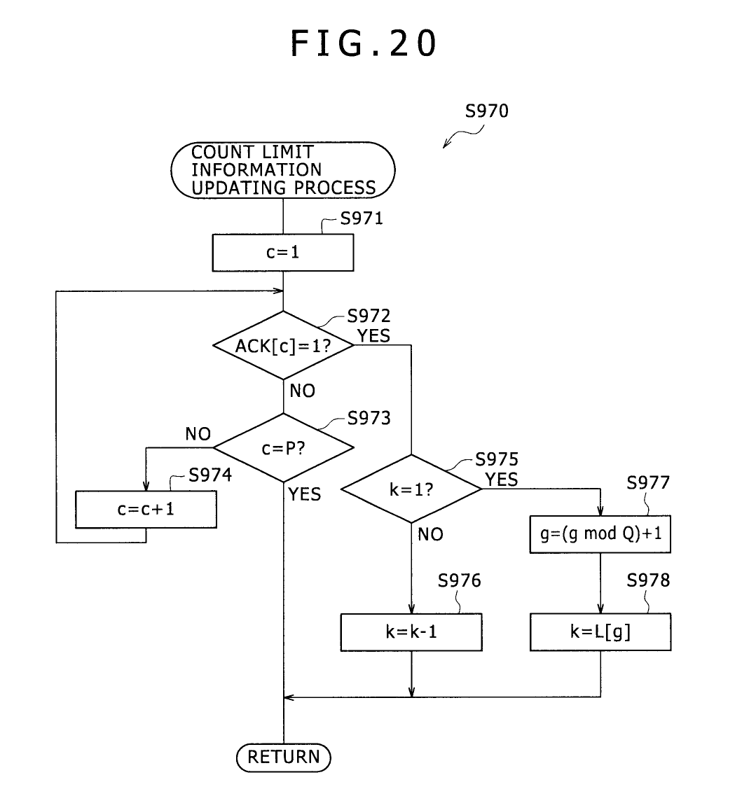

If the 0th bit of the request signal (REQ[0] value) is not found to be “1” (in step S916), then control is passed on to an ACK update value generation process for generating an update acknowledge signal (in step S950). Step S950 will be described later in detail by reference to FIG. 19. The ACK update value generation process is followed by a count limit information updating process for updating the count limit information (k) (in step S970). Step S970 will also be described later in detail by reference to FIG. 20.

A check is then made to determine whether or not to continue the acknowledge signal supply process (in step S919). If the acknowledge signal supply process is to be continued, step S912 is reached again. In this case, the enabled object detection information holding section 216 is caused to output the acknowledge signal held therein. The acknowledge signal supply process is continued illustratively when the next cycle is reached. The acknowledge signal supply process is terminated illustratively when the data processing apparatus 100 is switched off.

FIG. 19 is a flowchart showing a typical ACK update value generation process (step S950) performed by the acknowledge signal supply unit 630 of the third embodiment.

First, the group determination section 632 checks to determine whether the value of the group information supplied from the group information holding section 631 is “1” (in step S951). If the group information is found to be “1” (in step S951), then the variable “a” is initialized to “1” (that is the minimum value of the group 1 enabled object detection information) (in step S952). The group determination section 632 checks to determine whether the value of the request status signal (REQ[a] value) from the client identified by the variable “a” is “1” (in step S953). If the REQ[a] value is found to be “1” (in step S953), the acknowledge signal held by the acknowledge signal holding section 225 is updated to be an update signal in which the REQ[a] value is set to the ACK[a] value (in step S954).

If the REQ[a] value is not found to be “1” (in step S953), then a check is made to determine whether the variable “a” is the same as the maximum value of the group 1 enabled object detection information (M) (in step S955). If the variable “a” is not found to be the same as the maximum value of the group 1 enabled object detection information (M) (in step S955), then the variable “a” is incremented by “1” for an update (in step S956), before step S953 is reached again.

If the variable “a” is found to be the same as the maximum value of the group 1 enabled object detection information (M) (in step S955), then the group information and the count limit information are updated (in step S957). Specifically, the group determination section 632 updates the group information to “2” and the count limit information management section 636 updates the count limit information to “6” that is the group 2 maximum count L[2] (in step S957), before control is passed on to step S961.

If the group information is not found to be “1” (in step S951), then the variable “b” is initialized to “M+1” (that is the minimum value of the group 2 enabled object detection information) (step S958). A check is then made to determine whether the value of the request status signal (REQ[b] value) from the client identified by the variable “b” is “1” (in step S959). If the REQ[b] value is found to be “1” (in step S959), then the acknowledge signal held by the acknowledge signal holding section 225 is updated to be an acknowledge signal in which the REQ[b] value is set to the ACK[b] value (in step S961).

If the REQ[b] value is not found to be “1” (in step S959), a check is then made to determine whether the variable “b” is the same as the maximum value of the group 2 enabled object detection information (P) (in step S962). If the variable “b” is not found to be the same as the maximum value of the group 2 enabled object detection information (P) (in step S962), then the variable “b” is incremented by “1” for an update (in step S963), before step S959 is reached again.

If the variable “b” is found to be the same as the maximum value of the group 2 enabled object detection information (P) (in step S962), then the group information and the count limit information are updated (in step S964). Specifically, the group determination section 632 updates the group information to “1” and the count limit information management section 636 updates the count limit information to “6” that is the group 1 maximum count L[1] (in step S964), before control is passed on to step S954.

FIG. 20 is a flowchart showing a typical count limit information updating process (step S970) performed by the acknowledge signal supply unit 630 of the third embodiment.

First of all, the count limit information management section 636 initializes the variable “c” to “1” (that is the minimum value of the group 1 enabled object detection information) (in step S971). The count limit information management section 636 then checks to determine whether the value of the enable status signal (ACK[c] value) for the client identified by the variable “c” is “1” (in step S972). If the ACK[c] value is not found to be “1” (in step S972), a check is made to determine whether the variable “c” is the same as the maximum value of the group 2 enabled object detection information (P) (in step S973). If the variable “c” is not found to be the same as the maximum value of the group 2 enabled object detection information (P) (in step S973), then the variable “c” is incremented by “1” for an update (in step S974), before step S972 is reached again.

If the variable “c” is found to be the same as the maximum value of the group 2 enabled object detection information (P) (in step S973), then the count limit information updating process is brought to an end.

If the ACK[c] value is found to be “1” (in step S972), then a check is made to determine whether the value of the count limit information (k) is “1” (in step S975). If the value of the count limit information (k) is not found to be “1” (in step S975), then the count limit information “k” is decremented by “1” for an update (in step S976), and the count limit information updating process is terminated.

If the value of the count limit information (k) is found to be “1” (in step S975), the group information management section 634 updates the group information (in step S977). The count limit information management section 636 then updates the count limit information to the maximum value of the count limit information (k[g]) for the group of which the information has been updated (in step S978), before terminating the count limit information updating process.

As described above, the third embodiment involves classifying a plurality of clients into a plurality of groups and installing a plurality of enabled client detection units correspondingly for the groups. This structure improves the efficiency of data transfers.

Since the next client to be enabled for a data transfer is detected while another client is being currently enabled for the ongoing data transfer as explained above, the efficiency of data transfer is further improved.

What follows is a comparison between the data processing apparatus of the embodiment of this invention and a data processing apparatus having a queuing (FIFO; first-in first-out) arbiter.

The data processing apparatus equipped with the queuing arbiter is first explained below. This is a data processing apparatus that determines the client to perform a data transfer using an arbiter containing a queuing section that stores bus requests from a plurality of clients connected to a shared data bus (e.g., see U.S. Pat. No. 6,671,761). With this data processing apparatus, a plurality of bus requests are stored into the queuing section in the order in which they arrived. Basically, the data processing apparatus performs bus arbitration in a manner dealing with the bus requests on an FIFO basis (so as to determine the clients to use the bus one after another). Because this data processing apparatus is capable of accommodating a plurality of bus requests on the queue, the next data transfer to be performed (by a client) is highly likely to have been determined at the end of the current data transfer, especially when the bus is congested. This enables the data processing apparatus to suppress illustratively the elapsed times “12” through “15” in the timing chart of FIG. 4B applicable to traditional data processing apparatuses.

However, the above-outlined data processing apparatus with the queuing section has a major disadvantage: its scale of circuitry tends to become bloated. The larger the number of configured clients, the higher the possibility that numerous bus requests will come in simultaneously. This requires providing a larger number of queues on which to store the incoming bus requests. In order to determine the bus request to be registered at the end of each queue where a plurality of bus requests occur simultaneously, the data processing apparatus needs a circuit for prioritizing the bus requests. Because of the growing number of queues and the need to add the prioritizing circuit, the data processing apparatus is necessarily structured with complicated circuits for implementing complex algorithms.

Furthermore, the above-outlined data processing apparatus can suffer from a decline in bus efficiency while controlling access to its DRAM. In access control on the DRAM, the efficiency of bus use is increased if the wait time is reduced by minimizing changeovers between read access and write access, as described earlier in connection with the second embodiment of this invention. If the prioritizing circuit is further equipped with a circuit that rearranges the different types of access for wait time reduction, the algorithms of the data processing apparatus will be further complicated and need to be implemented by ever-complex circuitry.

According to the embodiment of the present invention, by contrast, the next client to be enabled for a data transfer is detected while the current client is being enabled for the ongoing data transfer as shown in FIG. 4A. This structure makes it possible to reduce the wait time stemming from changeovers between data transfers. Also, as shown in FIGS. 8 and 15, arrangements are made in such a manner as to raise the rate at which operations of the same access type are carried out consecutively. This makes it possible to further reduce the wait time by minimizing the changes in access type between read and write operations. Furthermore, as indicated in FIGS. 2 and 20, the enabled client detection unit 210 and acknowledge signal supply unit 220 may be constituted by simply-structured circuits such as counter circuits, selector circuits, AND circuits, fixed value generation circuits, and registers.

According to the present invention embodied as described above, the efficiency of data transfers is improved without recourse to complex circuits such as those adopted by the above-outlined data processing apparatus operating on the queuing method. In other words, the benefits of the data processing apparatus adopting the queuing method are realized just as effectively by the inventive arrangements using the appreciably simpler circuits and algorithms.

The embodiments and their variations described above are merely examples in which the present invention may be implemented. As is clear from above, the particulars of the embodiments and their variations in the description of the preferred embodiments correspond basically to the inventive matters claimed in the appended claims. Likewise, the inventive matters named in the appended claims correspond basically to the particulars with the same names in the description of the preferred embodiments. However, these embodiments and their variations and other examples of the present invention are not limitative thereof, and it should be understood by those skilled in the art that various modifications, combinations, sub-combinations and alterations may occur depending on design requirements and other factor in so far as they are within the scope of the appended claims or the equivalents thereof.

The above-described processes each formed by a series of steps may be considered to be a method containing the series of steps making up the processes, or may be regarded as either a program for causing a computer to execute these steps or a recording medium accommodating that program. The recording medium may be any one of CD's (Compact Discs), MD's (Mini-discs), DVD's (Digital Versatile Disks), memory cards, and Blu-ray Discs (registered trademark).

The present application contains subject matter related to that disclosed in Japanese Priority Patent Application JP 2010-000285 filed in the Japan Patent Office on Jan. 5, 2010, the entire content of which is hereby incorporated by reference.

What is claimed is:

1. An access control apparatus comprising:
a determination section configured such that given a plurality of data processing sections each effecting a data transfer to and from a data holding section via a bus, said determination section selects one of said data processing sections as a candidate object to be enabled for said data transfer, said determination section further determining whether or not to supply an enable signal to the data processing section selected as said candidate object thereby enabling the candidate data processing section to perform said data transfer depending on whether or not said candidate data processing section is found outputting a request signal requesting said data transfer; and
an update section configured such that while said data transfer is being performed based on said enable signal supplied as a result of the determination, said update section updates the current data processing section with another data processing section as said candidate object if the candidate data processing section selected as the next candidate object to be enabled for said data transfer is not found outputting said request signal.

2. The access control apparatus according to claim 1, wherein, from the time said data transfer is started based on said enable signal supplied as a result of the determination until the time said data transfer is terminated, said update section performs the update repeatedly in a predetermined sequence, said update section further stopping said update if the data processing section selected as said candidate object is found outputting said request signal.

3. The access control apparatus according to claim 1, wherein, while said data transfer is being performed based on said enable signal supplied as a result of the determination, if the data processing section selected as said candidate object as a result of the update is not found outputting said request signal, then said update section performs said update repeatedly even after completion of said data transfer, said update section further stopping said update if the data processing section selected as said candidate object is found outputting said request signal.

4. The access control apparatus according to claim 1, wherein said plurality of data processing sections are classified into a plurality of groups;
said update section identifies one data processing section in each of said groups so as to perform said update by selecting the identified data processing section as the candidate per group;
said access control apparatus further includes a selection section configured such that on the basis of the request signals output from said plurality of data processing sections, said selection section selects one of a plurality of candidates updated by said update section for each of said groups; and
depending on whether the data processing section selected by said selection section as said candidate has output said request signal, said determination section determines whether or not to supply said enable signal to the selected data processing section.

5. The access control apparatus according to claim 4, wherein said plurality of data processing sections are classified into said plurality of groups in such a manner that the data processing sections performing the same operation composed of either a read or a write are classified into the same group.

6. The access control apparatus according to claim 4, further comprising:
a group information holding section configured to hold group information for identifying one of said plurality of groups; and
a group update section configured to update said group information by successively updating the identified group with another group;
wherein, if said request signal is supplied from the data processing section belonging to the group identified by said group information, then said selection section selects the candidate of the identified group as said one candidate, and
if said request signal is not supplied from the data processing section belonging to the group identified by said group information, then said selection section selects the candidate of another group other than the identified group as said one candidate.

7. The access control apparatus according to claim 1, wherein said update section continuously selects said data processing section performing the same operation composed of either a read or a write as said next candidate object to be enabled for said data transfer.

8. A data processing apparatus comprising:
a data holding section configured to hold data;
a plurality of data processing sections each configured to effect a data transfer to and from said data holding section;
a bus configured to connect said data holding section with said plurality of data processing sections;
a determination section configured to select one of said plurality of data processing sections as a candidate object to be enabled for said data transfer, said determination section further determining whether or not to supply an enable signal to the data processing section selected as said candidate object thereby enabling the candidate data processing section to perform said data transfer depending on whether or not said candidate data processing section is found outputting a request signal requesting said data transfer; and
an update section configured such that while said data transfer is being performed based on said enable signal supplied as a result of the determination, said update section updates the current data processing section with another data processing section as said candidate object if the candidate data processing section selected as the next candidate object to be enabled for said data transfer is not found outputting said request signal.

9. An access control method comprising the steps of:
given a plurality of data processing sections each effecting a data transfer to and from a data holding section via a bus, selecting one of said data processing sections as a candidate object to be enabled for said data transfer;
determining whether or not to supply an enable signal to the data processing section selected as said candidate object thereby enabling the candidate data processing section to perform said data transfer depending on whether or not said candidate data processing section is found outputting a request signal requesting said data transfer; and
while said data transfer is being performed based on said enable signal supplied as a result of the determination, updating the current data processing section with another data processing section as said candidate object if the candidate data processing section selected as the next candidate object to be enabled for said data transfer is not found outputting said request signal.

10. A program for causing a computer to perform a procedure comprising the steps of:
given a plurality of data processing sections each effecting a data transfer to and from a data holding section via a bus, selecting one of said data processing sections as a candidate object to be enabled for said data transfer;
determining whether or not to supply an enable signal to the data processing section selected as said candidate object thereby enabling the candidate data processing section to perform said data transfer depending on whether or not said candidate data processing section is found outputting a request signal requesting said data transfer; and
while said data transfer is being performed based on said enable signal supplied as a result of the determination, updating the current data processing section with another data processing section as said candidate object if the candidate data processing section selected as the next candidate object to be enabled for said data transfer is not found outputting said request signal.

11. An access control apparatus comprising:
determination means configured such that given a plurality of data processing means each effecting a data transfer to and from data holding means via a bus, said determination means selects one of said data processing means as a candidate object to be enabled for said data transfer, said determination means further determining whether or not to supply an enable signal to the data processing means selected as said candidate object thereby enabling the candidate data processing means to perform said data transfer depending on whether or not said candidate data processing means is found outputting a request signal requesting said data transfer; and
update means configured such that while said data transfer is being performed based on said enable signal supplied as a result of the determination, said update means updates the current data processing means with another data processing means as said candidate object if the candidate data processing means selected as the next candidate object to be enabled for said data transfer is not found outputting said request signal.
